(19) United States
(12) Patent Application Publication
(10) Pub. No.: US 2026/0212212 A1
(43) Pub. Date: Jul. 23, 2026

(54) COMPUTING SYSTEM AND METHOD FOR CREATING MACHINE-LEARNING MODELS UTILIZING A MANAGED CREW OF AI AGENTS

(71) Applicant: Capital One Financial Corporation, McLean, VA (US)

(72) Inventors: Ashkan Golgoon, Glenview, IL (US); Izunna Okpala, Chicago, IL (US); Arjun Ravi Kannan, Buffalo Grove, IL (US)

(21) Appl. No.: 19/035,080

(22) Filed: Jan. 23, 2025

(51) Int. Cl. G06N 3/10; G06N 3/0475

(52) U.S. Cl. CPC G06N 3/10; G06N 3/0475

(57) ABSTRACT

A computing system is configured to: (i) utilize an orchestrator AI agent that is configured to use a generative AI model to decompose a prompt for generating a machine-learning model into modelling tasks, generate instructions for a set of modelling AI agents, pass the instructions for the set of modelling AI agents to the modelling AI agents, and receive modelling output from the modelling AI agents, (iii) provide the instructions for the modelling AI agents to the modelling AI agents that are each configured to utilize a generative AI model to, based on the set of instructions, perform a modelling function corresponding to a modelling task and thereby generate modelling output corresponding to the modelling task, and pass the modelling output to the orchestrator AI agent, and (iv) create the machine-learning model based on the modelling output received by the orchestrator AI agent.

### BACKGROUND

Machine-learning models, generally, can be utilized to predict behavior and/or outcomes based on an analysis of input data, in view of prior training of the machine-learning models. Various organizations utilize machine-learning models to, for example, predict outcomes of various processes performed within the organization, which may allow meaningful insights to be derived based on output of the machine-learning models. For instance, based on an analysis of values for variables predicted by machine-learning models, patterns may be identified and utilized to predict behavior related to an organization’s processes or to forecast outcomes related to an organization’s processes, among other possibilities.

Disclosed herein is new technology for creating and/or independently validating machine-learning models utilizing a managed crew of artificial intelligence (AI) agents.

In one aspect, the disclosed technology may take the form of a method to be carried out by a computing platform that involves (i) receiving a prompt that comprises (a) a request to create a machine-learning model and (b) an identifier for a dataset, (ii) providing the prompt to an orchestrator artificial intelligence (AI) agent that is configured to (a) utilize a first generative AI model to decompose the request to generate the machine-learning model into a set of modelling tasks, (b) generate instructions for a set of modelling AI agents, each modelling AI agent in the set of modelling AI agents configured to carry out a corresponding task of the set of modelling tasks (c) pass the identifier for the dataset and the instructions for the set of modelling AI agents to the set of modelling AI agents, and (d) receive modelling output from the set of modelling AI agents, (iii) providing, via the orchestrator AI agent, the instructions for the set of modelling AI agents to the set of modelling AI agents that are each configured to (a) utilize a second generative AI model to, based on respective instructions of the set of instructions, generate input to a respective modelling function of a set of modelling functions for the modelling AI agents, the respective modelling function corresponding to a respective modelling task of the set of modelling tasks, (b) based on the input for the modeling function, carry out the respective modelling function thereby generate respective modelling output corresponding to the respective modelling task, and (c) pass the respective modelling output corresponding to the respective modelling task to the orchestrator AI agent, (iv) create the machine-learning model based on the modelling output received by the orchestrator AI agent, and (v) cause an indication of the modelling output to be presented.

The orchestrator AI agent may take any of various forms and/or provide various functionalities. In one example, the functionality for causing the computing platform to create the machine-learning model based on the modelling output may involve using the orchestrator AI agent to create the machine-learning model based on the modelling output. In another example, the orchestrator AI agent is further configured to store the modelling output and the set of modelling agents may access the modelling output via the orchestrator AI agent. In another example, passing, by the respective modelling AI agent, the respective modelling output may involve passing the respective modelling output to (i) the orchestrator AI agent, (ii) another modelling agent of the set of modelling AI agents, (iii) another set of AI agents, or (iv) combinations thereof. In yet another example, the set of modelling AI agents may include one or more of an exploratory data analysis (EDA) AI agent, a feature-engineering AI agent, a model-selection AI agent, a hyperparameter-tuning AI agent, a model-training AI agent, a model-evaluation AI agent, a model-documentation agent, or combinations thereof.

In yet another example, each of the set of modelling AI agents may include a respective role parameter. The respective role parameters may take any of various forms. For example, each respective role parameter may be one of a data scientist role, a machine-learning engineer role, or combinations thereof.

The modelling AI agents may take any of various forms and/or provide various functionalities. In one example, at least one of the set of modelling AI agents generates the input for the respective modelling function of the set of modelling functions based on the dataset.

The first and second generative AI model(s) may take any of various forms. For example, the second generative AI model may be the first generative AI model.

In another aspect, the disclosed technology may take the form of a method to be carried out by a computing platform that involves (i) receiving a prompt that comprises (a) a request to validate a machine-learning model and (b) an identifier for the machine-learning model, (ii) providing the prompt to an orchestrator artificial intelligence (AI) agent that is configured to (a) utilize a first generative AI model to decompose the request to validate the machine-learning model into a set of risk-management tasks, (b) generate instructions for a set of risk-management AI agents, each risk-management AI agent in the set of risk-management AI agents configured to carry out a corresponding task of the set of risk-management tasks (c) pass the identifier for the machine-learning model and the instructions for the set of risk-management AI agents to the set of risk-management AI agents, and (d) receive risk-management output from the set of risk-management AI agents, (iii) providing, via the orchestrator AI agent, the instructions for the set of risk-management AI agents to the set of risk-management AI agents that are each configured to (a) utilize a second generative AI model to, based on respective instructions of the set of instructions, generate input to a respective risk-management function of a set of risk-management functions for the risk-management AI agents, the respective risk-management function corresponding to a respective risk-management task of the set of risk-management tasks, (b) based on the input for the risk-management function, carry out the respective risk-management function thereby generate respective risk-management output corresponding to the respective risk-management task, and (c) pass the respective risk-management output corresponding to the respective risk-management task to the orchestrator AI agent, and (iv) cause an indication of the risk-management output to be presented.

The set of risk-management AI agents may take any of various forms and/or provide additional or alternative functionality. In one example, the set of risk-management AI agents may include or more of a model-documentation-compliance-check AI agent, a conceptual-soundness AI agent, an outcome-analyzer AI agent, a model-risk-management documentation AI agent, or combinations thereof. In another example, each of the set of risk-management AI agents may comprise a respective role parameter. In some such examples, each respective role parameter comprises one of a data scientist role, a machine-learning engineer role, a secretary role, a technical-writer role, or combinations thereof. In another example, at least one of the set of risk-management AI agents may be configured to generate the input for the respective risk-management function of the set of risk-management functions based on the machine-learning model.

The orchestrator AI agent may take any of various forms and/or provide additional or alternative functionality. In one example, the orchestrator AI agent may further be configured to store the risk-management output and, in some such examples, the set of risk-management AI agents may access the risk-management output. In another example, the orchestrator AI agent may include a model risk management manager role parameter.

The first and second generative AI model(s) may take any of various forms. For example, the second generative AI model may be the first generative AI model.

In another aspect, disclosed herein is a computing platform that includes at least one processor, at least one non-transitory computer-readable medium, and program instructions stored on the at least one non-transitory computer-readable medium that are executable by the at least one processor to cause the computing platform to carry out the functions disclosed herein, including but not limited to the functions of the foregoing methods.

In yet another aspect, disclosed herein is a non-transitory computer-readable medium that is provisioned with program instructions that are executable to cause a computing platform to carry out the functions disclosed herein, including but not limited to the functions of the foregoing methods.

One of ordinary skill in the art will appreciate these as well as numerous other aspects in reading the following disclosure.

### BRIEF DESCRIPTION OF THE DRAWINGS

FIG. 1 depicts an example network environment in which example embodiments may be implemented.

FIG. 2 depicts an example block diagram for an AI-based software architecture 200 that utilizes a managed crew of AI agents to create and evaluate machine-learning models.

FIG. 3 depicts an example block diagram for a modelling crew for use in the AI-based software architecture 200 that utilizes a managed crew of artificial intelligence (AI) agents to create machine-learning models.

FIG. 4 depicts an example block diagram for a risk-management crew for use in the AI-based software architecture 200 that utilizes a managed crew of artificial intelligence (AI) agents to evaluate machine-learning models.

FIG. 5 depicts one possible implementation of functionality that may be carried out by the example AI-based software architecture of FIG. 3.

FIG. 6 depicts one possible implementation of orchestrator AI agent(s) functionality that may be carried out by the example AI-based software architecture of FIG. 3.

FIG. 7 depicts one possible implementation of AI agent functionality that may be carried out by the example AI-based software architecture of FIG. 3.

FIG. 8 is a simplified block diagram illustrating some structural components that may be included in an example computing platform that may be configured to perform some or all of the server-side functions disclosed herein.

FIG. 9 is a simplified block diagram illustrating some structural components that may be included in an example client device that may be configured to perform some or all of the client-side functions disclosed herein.

Features, aspects, and advantages of the presently disclosed technology may be better understood with regard to the following description, appended claims, and accompanying drawings, as listed below. The drawings are for the purpose of illustrating example embodiments, but those of ordinary skill in the art will understand that the technology disclosed herein is not limited to the arrangements and/or instrumentality shown in the drawings.

### DETAILED DESCRIPTION

As noted above, organizations, generally, may train and use various machine-learning models to predict behavior and/or outcomes related to processes within the organizations. These machine-learning models may be trained based on historical data related to a given process within the organization and, then, may receive, as input, current data associated with the given process. The machine-learning models then analyze the current data associated with the given process to provide output which may make predictions related to the given process (e.g., output predicting behavior, output predicting outcomes of a process, output a generated classification decision, among other possibilities.

Utilizing machine-learning models for outcome-analysis may be particularly valuable in making decisions and/or predicting outcomes for processes that are governed by regulatory standards. These processes may involve approvals/denials of services (e.g., loans, contracts, bids, etc.), worthiness of services (e.g., credit approval, determination of suitability for access to the services, etc.), among other things.

Accordingly, various organizations may utilize machine-learning models for predicting and/or verifying the outcomes of regulation-based determinations for access to services and/or processes related to the various organizations. To illustrate with an example, various organizations may conduct various operations that are regulated by rules that are imposed via various government agencies (e.g., the Federal Housing Finance Agency (FHFA), the Consumer Financial Protection Bureau (CFPB), the Federal Reserve Board (FRM), etc.) and/or various government acts (e.g., the Equal Credit Opportunity Act (ECOA), the Unfair, Deceptive, or Abusive Acts or Practices (UDAAP) regulations, the Telephone Consumer Protection Act (TCPA), etc.) carried out by such agencies. Various organizations may have rules imposed upon their processes by, for example, other government institutions, non-government organizations (NGOs), standards bodies, trade associations, union contracts, etc.). Accordingly, it is desired to generate machine-learning models utilizing data associated with these rules to predict outcomes related to such rules, using current data.

Various computer-based technologies currently exist for creating and utilizing such machine-learning models to analyze data associated with such a process. For instance, various complex, computer-based technologies currently exist for creating machine-learning models, including but not limited to techniques for training machine-learning models, examples of which may include a neural network technique (which is sometimes referred to as “deep learning”), a regression technique, a k-Nearest Neighbor (kNN) technique, a decision-tree technique, a support vector machines (SVM) technique, a Bayesian technique, an ensemble technique, a clustering technique, an association-rule-learning technique, a dimensionality reduction technique, an optimization technique such as gradient descent, a regularization technique, and/or a reinforcement technique, among other possible types of machine learning techniques. Further, the existing computer-based technologies for creating machine-learning models include various techniques for tuning the hyperparameters of such models, including but not limited to techniques such as grid search or random search, among other possibilities. In practice, these technologies involve advanced functionality that requires the use of computers and typically utilize large volumes of complex data that cannot be practically evaluated by humans.

However, the existing computer-based technologies for creating machine-learning models to analyze data associated with a process within an organization have a number of drawbacks and problems.

For example, existing computer-based technologies for creating machine-learning models for analyzing data associated with a process within an organization are typically designed for use by individuals with specialized knowledge and experience in the field of machine-learning (e.g., data scientists or the like). Accordingly, these technologies for creating machine-learning models are generally not suitable for use by other “non-expert” individuals that may wish to analyze data to generate predictions, make classification decisions, and the like, which limits the usefulness and value of existing technologies.

Further, creating machine-learning models using existing technologies is typically a complex, cumbersome, time consuming, and resource intensive task that can only be carried out by a limited subset of qualified individuals. This introduces more time delay and cost into the process of generating machine learning models.

As an illustrative example, to create a machine-learning model utilizing existing computer-based technologies, an organization may require (i) an individual who is an expert in identifying data necessary to train a model to make decisions that are in accordance with a given regulation, (ii) one or more data analysts to choose and/or refine data to be used for training the model and/or as input to the model, (iii) one or more data scientists to select the type of model (e.g., what type of modelling algorithm(s)) to be used by the machine-learning model, (iv) one or more data scientists to generate and/or tune hyperparameters for the machine-learning model, (vi) one or more data scientists to test and/or validate performance of the machine-learning model, and/or (vii) one or more computer scientists to generate code for executing one or more of the aforementioned functions, among other individuals performing other tasks associated with creating a machine-learning model. These processes, involving many members of an organization (or perhaps contractors hired by the organization) may introduce various inefficiencies and/or may be quite cost-intensive and/or time intensive for the organization.

Still, another problem with existing computer-based technologies for generating machine-learning models is that such technologies often require each new machine-learning model to be created from scratch, rather than leveraging the commonalities between different categories of machine-learning models in order to streamline the process of creating new categories of machine-learning models. As a result, the existing computer-based technologies for generating machine-learning models lacks scalability.

The existing computer-based technologies for creating machine-learning models to analyze data associated with a process within an organization suffer from other problems as well.

To address these and other problems with the existing technology for creating machine-learning models to analyze data associated with a process within an organization, disclosed herein is AI-based software technology for (i) creating machine-learning models utilizing a managed crew of AI agents and (ii) validating machine-learning models using a managed crew of AI agents. At a high level, the disclosed AI-based software technology comprises (i) front-end software that interacts with the user by receiving information related to a request to create and/or validate a machine-learning model and (ii) back-end software that interprets the request and creates and/or validates the machine-learning model.

In practice, the back-end software may function to (i) receive a prompt that comprises (a) a request to create a machine-learning model and (b) an identifier for a dataset, (ii) provide the prompt to an orchestrator AI agent(s) that is configured to (a) utilize a first generative AI model to decompose the request to generate the machine-learning model into a set of modelling tasks, (b) generates instructions for a set of modelling AI agents, each modelling AI agent in the set of modelling AI agents configured to carry out a corresponding task of the set of modelling tasks (c) passes the identifier for the dataset and the instructions for the set of modelling AI agents to the set of modelling AI agents, and (d) receives modelling output from the set of modelling AI agents, (iii) provide, via the orchestrator AI agent(s) the set of modelling tasks to the set of modelling AI agents that are each configured to (a) utilize a second generative AI model to, based on respective instructions of the set of instructions, generate input to a respective modelling function of a set of modelling functions for the modelling AI agents, the respective modelling function corresponding to a respective modelling task of the set of modelling tasks, (b) based on the input for the modeling function, carry out the respective modelling function to thereby generate respective modelling output corresponding to the respective modelling task, and (c) pass the respective modelling output corresponding to the respective modelling task to the orchestrator AI agent(s), (iv) create the machine-learning model based on the modelling output, and (v) cause an indication of the modelling output to be presented.

In addition, a similar approach may be used to validate and test machine-learning models (that are either (i) created using the disclosed AI-based software technology or (ii) created using another technology). In particular, the orchestrator AI agent(s) may generate instructions for a set of risk-management AI agents that each carry out a set of risk management tasks associated with the created machine-learning model.

In practice, the back-end software may function to (i) receive a prompt that comprises (a) a request to validate a machine-learning model and (b) an identifier for the machine-learning model, (ii) provide the prompt to an orchestrator AI agent(s) that is configured to (a) utilize a first generative AI model to decompose the request to validate the machine-learning model into a set of risk-management tasks, (b) generates instructions for a set of risk-management AI agents, each risk-management AI agent in the set of risk-management AI agents configured to carry out a corresponding task of the set of risk-management tasks (c) passes the identifier for the machine-learning model and the instructions for the set of risk-management AI agents to the set of risk-management AI agents, and (d) receives risk-management output from the set of risk-management AI agents, (iii) provide, via the orchestrator AI agent(s) the set of risk-management tasks to the set of risk-management AI agents that are each configured to (a) utilize a second generative AI model to, based on respective instructions of the set of instructions, generate input to a respective risk-management function of a set of risk-management functions for the risk-management AI agents, the respective risk-management function corresponding to a respective risk-management task of the set of risk-management tasks, (b) based on the input for the risk-management function, carry out the respective risk-management function to thereby generate respective risk-management output corresponding to the respective modelling task, and (c) pass the respective risk-management output corresponding to the respective risk-management task to the orchestrator AI agent(s), and (iv) cause an indication of the modelling output to be presented.

By utilizing the disclosed AI-based software technology, users who may otherwise be novices at creating machine-learning models and/or validating machine-learning models may now be able to create and validate the functionality of complex models, based on relatively simple input instructions. This may enable organizations to generate and verify machine-learning models far more easily and quickly promoting greatly increased efficiency in terms of time, labor, and cost.

The disclosed AI-based software technology may be particularly useful in creating machine-learning models for making decisions and/or predicting outcomes for processes that are governed by regulatory standards (e.g., machine-learning models for fraud detection, consumer lending, etc.).

As demonstrated below, the AI-based software technology improves upon the existing computer-based technologies for creating machine-learning models in various other ways as well.

In practice, the AI-based software technology may take the form of one or more software applications that are hosted on a back-end computing platform and is accessible by client devices over a communication path that typically includes the Internet (among other data networks that may be included). In this respect, the AI-based software technology may comprise server-side software installed on the back-end computing platform as well as client-side software that runs on the client devices and interacts with the server-side software, which could take the form of a client application running in a web browser (sometimes referred to as a “web application”), a native desktop application, or a mobile application, among other possibilities. However, the disclosed AI-based software technology could take other forms and/or be implemented in other manners as well.

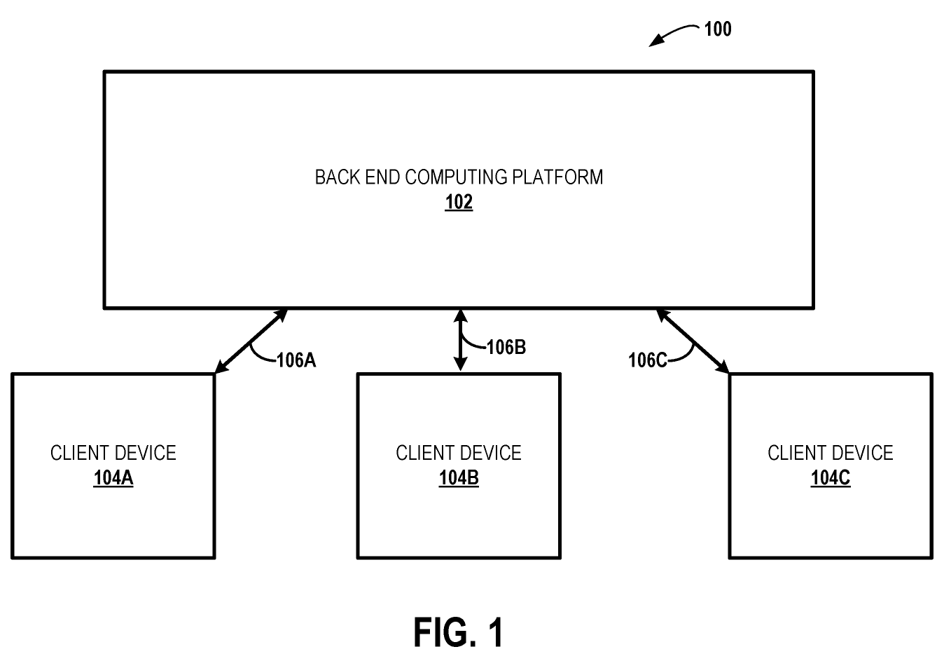

Turning now to the figures, FIG. 1 depicts an example network environment 100 in which an AI-based software technology may be implemented. As shown in FIG. 1, the network environment 100 includes a back-end computing platform 102 that may be communicatively coupled to one or more client devices 104, which as shown includes the client device 104A, the client device 104B, and the client device 104C. Although the client devices 104 are depicted by three devices as shown for the sake of simplicity in illustration, it should be understood that the client devices 104 may represent more or less than three devices without departing from the spirit and scope of this disclosure.

Broadly speaking, the back-end computing platform 102 may comprise one or more computing systems that have been provisioned with back-end software for an AI-based software technology, which may include program code for carrying out one or more of the platform-side functions disclosed herein. The one or more computing systems of back-end computing platform 102 may collectively comprise some set of physical computing resources (e.g., one or more processors, data storage system, communication interfaces, etc.), which may take various forms and be arranged in various manners.

For instance, as one possibility, the back-end computing platform 102 may comprise computing infrastructure of a public, private, and/or hybrid cloud (e.g., computing and/or storage clusters) that has been provisioned with back-end software for the AI-based software technology. In this respect, the entity that owns and operates the back-end computing platform 102 may supply its own cloud infrastructure or obtain the cloud infrastructure from a third-party provider of “on demand” computing resources, such as Amazon Web Services (AWS) or the like. As another possibility, the back-end computing platform 102 may comprise one or more dedicated servers that have been provisioned with back-end software.

Further, in practice, the back-end software installed at the back-end computing platform 102 may be implemented using any of various software architecture styles, examples of which may include a microservices architecture, a service-oriented architecture, and/or a serverless architecture, among other possibilities, as well as any of various deployment patterns, examples of which may include a container-based deployment pattern, a virtual-machine-based deployment pattern, and/or a Lambda-function-based deployment pattern, among other possibilities.

Further yet, although not shown in FIG. 1, the back-end software installed at the back-end computing platform 102 may interact with a data storage layer of the back-end computing platform 102, which may comprise data stores of various different forms, examples of which may include relational databases (e.g., Online Transactional Processing (OLTP) databases), NoSQL databases (e.g., columnar databases, document databases, key-value databases, graph databases, etc.), file-based data stores (e.g., Hadoop Distributed File System), object-based data stores (e.g., Amazon S3), data warehouses (which could be based on one or more of the foregoing types of data stores), data lakes (which could be based on one or more of the foregoing types of data stores), message queues, or streaming event queues, among other possibilities.

The back-end computing platform 102 may comprise various other components and take various other forms as well.

In turn, the client devices 104 may each be any computing device that is capable of running front-end software of the AI-based software technology, which may include program code for carrying out the client-side functions disclosed herein. In this respect, the client devices 104 may each include hardware components such as one or more processors, computer-readable mediums, communication interfaces, and input/output (I/O) components (or interfaces for connecting thereto), among others, as well as software components that facilitate the client device’s ability to run the front-end software (e.g., operating system software, web browser software, etc.). As representative examples, the client devices 104 may each take the form of a desktop computer, a spatial computer, a laptop, a netbook, a tablet, a smartphone, and/or a personal digital assistant (PDA), among other possibilities.

As further depicted in FIG. 1, the back-end computing platform 102 is configured to interact with the client devices 104 over respective communication paths 106, of which communication paths 106A, 106B, and 106C are shown as examples. In this respect, each respective communication path 106 between the back-end computing platform 102 and one of the client devices 104 may generally comprise one or more communication networks and/or communications links, which may take any of various forms. For instance, each respective communication path 106 with the back-end computing platform 102 may include any one or more of Personal Area Networks (PANs), Local-Area Networks (LANs), Wide-Area Networks (WANs) such as the Internet or cellular networks, cloud networks, and/or point-to-point links, among other possibilities. Further, the communication networks and/or links that make up each respective communication path 106 with the back-end computing platform 102 may be wireless, wired, or some combination thereof, and may carry data according to any of various different communication protocols. Further yet, communications over each respective communication path 106 could be carried out via an Application Programming Interface (API), among other possibilities. Still further, although not shown, the respective communication paths 106 between the client devices 104 and the back-end computing platform 102 may also include one or more intermediate systems. For example, it is possible that the back-end computing platform 102 may communicate with a given client device 104 via one or more intermediary systems, such as a host server (not shown). The respective communication paths 106 between the back-end computing platform 102 and the client devices 104 may take other forms as well.

Although not shown in FIG. 1, the back-end computing platform 102 may also be configured to receive data, such as a dataset used for creating a machine-learning model, from one or more external data sources, such as an external database and/or another back-end computing platform or platforms. Such data sources—and the data output by such data sources—may take various forms.

It should be understood that the network environment 100 depicted in FIG. 1 is one example of a network environment in which an AI-based software technology may be implemented. Numerous other arrangements are possible and contemplated herein. For instance, other network configurations may include additional components not pictured and/or more or fewer of the pictured components.

In practice, the disclosed AI-based software technology may be integrated into a software application as a feature or the disclosed AI-based software technology provided as a standalone software application, among other possibilities. For instance, as one possible implementation, the disclosed AI-based software technology may be integrated into an application comprising both front-end software running on client devices (e.g., client devices 104A-C of FIG. 1) that are accessible to individuals and back-end software running on a back-end computing platform (e.g., back-end computing platform 102 of FIG. 1) that interacts with and/or drives the front-end software. As another possible implementation, the disclosed AI-based software technology may be integrated into a software application comprising front-end client software that runs on client devices without interaction with a back-end computing platform. The disclosed AI-based software technology may take other forms as well.

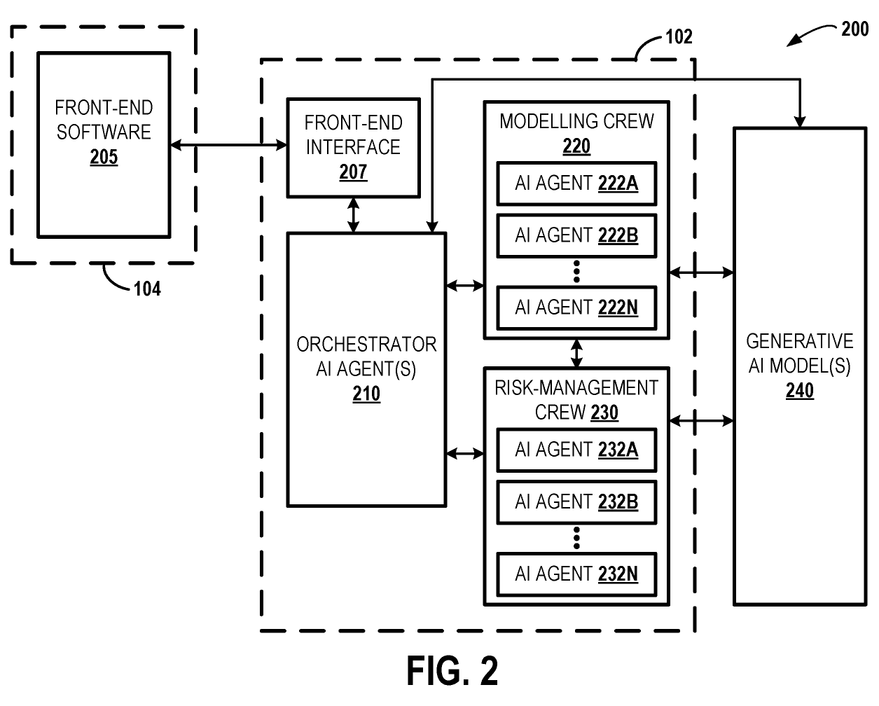

Turning now to FIG. 2, an example block diagram for an AI-based software architecture 200 utilizing the disclosed AI-based software technology is illustrated. In practice, the example AI-based software architecture 200 may be encoded in the form of program instructions that are executable by one or more processors of a computing platform, and for purposes of illustration, the AI-based software architecture 200 is described as being installed on and executed by the back-end computing platform 102 of FIG. 1, but it should be understood that the example AI-based software architecture 200 may be installed on and executed by any one or more computing platforms that are capable of performing the example operations of the AI-based software architecture 200. Further, it should be understood that the example AI-based software architecture 200 is merely described in this manner for the sake of clarity and explanation and that the example operations may be implemented in various other manners, including the possibility that logical blocks may be added, removed, rearranged into different orders, combined into fewer blocks, and/or separated into additional blocks depending upon the particular example.

As shown in FIG. 2, the example AI-based software architecture 200 comprises a front-end interface 207, an orchestrator AI agent(s) 210, a modelling crew 220 comprising a set of modelling AI agents 222A-N, and (optionally) a risk-management crew 230 comprising a set of risk-management AI agents 232A-N. Additionally, as shown in FIG. 2, the AI-based software architecture 200 may interface with client devices 104 running front-end software for implementing the disclosed AI-based software technology, which may include front-end software 205 for the disclosed AI-based software technology. Additionally yet, as shown in FIG. 2, the example AI-based software architecture 200 may interface with at least one generative AI model 240, which may either be hosted on a separate computing system that is accessible over a network-based communication path (e.g., via an API or the like) or be hosted on the back-end computing platform 102. Each of these components will now be described in further detail.

To begin, a client device 104 runs disclosed front-end software 205 that generally functions to provide an input/output interface between a user of the client device 104 and the back-end computing platform 102 that hosts software for the disclosed AI-based software technology. At a high level, to the disclosed front-end software may provide functionality for (i) presenting the user with an interface for inputting information for prompts for creating and/or validating machine-learning models and (ii) transmitting the prompts that are based on input by the user to the back-end computing platform 102. Each of these functions may take any of various forms.

For instance, as one possibility, the function of presenting the user interface for inputting prompts for creating and/or validating machine-learning models may involve (i) receiving a communication from the back-end computing platform 102 that instructs the client device 104 to present the user with the user interface, and (ii) thereafter presenting the user with the user interface (e.g., via a display screen controlled by the client device 104). In practice, this communication may take the form of one or more messages (e.g., one or more HTTP messages) that are sent over the communication path 106 between the back-end computing platform 102 and the client device 104 and, in at least some implementations, the communication may be sent via one or more APIs.

The function of presenting the user with the interface for inputting prompts for creating and/or validating machine-learning models may take various other forms as well.

Further, the interface may enable the user to input prompts for creating and/or validating machine-learning models in any of various manners. For instance, as one possibility, a user may access and use the front-end software running on the client device 104 to input a text-based natural-language request and/or a voice-based natural-language request (e.g., via a chat interface or the like) indicative of information for prompts for creating and/or validating machine-learning models. The interface may enable the user to input prompts for creating and/or validating machine-learning models in other manners as well.

Further yet, the interface for inputting prompts for creating and/or validating machine-learning models may take any of various forms. For instance, the interface for inputting natural-language requests may comprise a GUI view that includes one or more input-control elements (e.g., a text box) that enable the user to input prompts for creating and/or validating machine-learning models in a text format. In one example, the GUI view may comprise a chat interface that may be accessed within the GUI view, beside the GUI view, or overlaid on the GUI view. Additionally or alternatively, the interface for inputting prompts for creating and/or validating machine-learning models may comprise an input-control element that enables a user to initiate a session for inputting natural-language requests in an audio format using an I/O component of the client device 104 that captures audio (e.g., a microphone). The interface for inputting natural-language requests indicative of prompts for creating and/or validating machine-learning models may take various other forms, as well.

After the client device 104 running the front-end software receives the prompts for creating and/or validating a machine-learning model, it then transmits the prompts for creating and/or validating machine-learning models to the front-end interface 207. In practice, the client device 104 may encode the natural-language request into a communication that is sent to the back-end computing platform 102. This communication may take the form of one or more messages (e.g., one or more HTTP messages) that are sent over the communication path 106 between the client device 104 and the back-end computing platform 102, and in at least some implementations, the communication may be sent via one or more APIs.

The front-end interface 207 generally functions to interface with the client device(s) 104 running the front-end software, so as to receive communications from the client devices 104 via the communication paths 106 and/or send communications to the client devices 104 via the communication paths 106. For instance, at a high level, the functionality performed by the front-end interface 207 in accordance with the present disclosure may involve (i) receiving, from one of the client devices 104, prompts for creating and/or validating machine-learning models (ii) passing the received prompts for creating and/or validating machine-learning models to the orchestrator AI agent(s) 210, (iii) receiving a response to the received prompts for creating and/or validating machine-learning models comprising an indication of output of one or more of the modelling crew 220, the risk-management crew 230, or combinations thereof, and (iv) based on the response, causing the client device 104 to update a GUI being presented to the user.

The prompts for creating and/or validating machine-learning models that are received by the front-end interface 207 may take any of various forms. For instance, a prompt for creating and/or validating a machine learning model may comprise (i) a request to create and/or validating a machine-learning model and (ii) an identifier for a dataset for the machine-learning model and/or an identifier for the machine-learning model, itself. The prompt for creating and/or validating the machine-learning model may further comprise additional information that can be utilized in creating and/or validating the machine-learning model and may take various other forms.

The information input for the request to create and/or validate the machine-learning model may be based on a natural-language request input to the back-end computing platform 102 (e.g., input via a client device 104). Additionally or alternatively, information for the request to create and/or validate the machine-learning model may be based on inputs other than natural language (e.g., parameters chosen via one or more input-control elements of a GUI, etc.). In some examples, the front-end software 205 and/or the front-end interface 207 may utilize the information input via the client device 104 to determine instructions for the request to create and/or validate the machine-learning model in a format configured as input for the orchestrator AI agent(s) 210 (e.g., based on an analysis of a natural-language request, generating input for the orchestrator AI agent(s) 210 indicative of a request to create and/or validate a machine-learning model). The request to create and/or validate the machine-learning model may take various other forms, as well.

The identifier for the dataset and/or the machine-learning model may take any of various forms. For example, the identifier may comprise a file path or similar pointer that can be utilized by the AI-based software architecture 200 (e.g., using the front-end software 205 and/or the front-end interface 207) to determine one or more locations of data for the dataset and/or the machine-learning model within one or more data storage layers of (or associated with) the back-end computing platform 102. For example, input for generating the identifier for the dataset may take the form of selecting a source of data and/or a range of data via one or more input-control elements on a GUI (e.g., presented via a client device 104) that identifies the dataset within a data storage layer of (or associated with) the back-end computing platform 102. Alternatively, the identifier for the dataset may comprise the dataset itself, for example, as an uploaded dataset by a user of a client device 104 and/or via a data transfer to the back-end computing platform 102 from another data storage layer, another computing device, and/or the client device 104 itself. The identifier for the dataset may take various other forms, as well.

Further, input for generating the identifier for the machine-learning model may take the form of selecting a machine-learning model from a set of machine-learning models presented to a user (e.g., presented via a client device 104) that identifies the machine-learning model within bounds of the back-end computing platform 102. Alternatively, the identifier for the machine-learning model may comprise the machine-learning model itself, for example, as an uploaded machine-learning model by a user of a client device 104 and/or via a data transfer to the back-end computing platform 102 from another data storage layer, another computing device, and/or the client device 104 itself. The identifier for the machine-learning model may take various other forms, as well.

The function of causing the client device 104 to update the GUI being presented to the user may take any of various forms. For instance, as one possibility, the function of causing the client device 104 to update the GUI may involve (i) the back-end computing platform 102 transmitting a communication to the client device 104 that instructs the client device 104 to present the user with a GUI updated to reflect output of one or more of the modelling crew 220, the risk-management crew 230, or combinations thereof, (ii) the client device 104 receiving the communication, and (iii) the client device 104 thereafter presenting the user with an indication of output of one or more of the modelling crew 220, the risk-management crew 230, or combinations thereof (e.g., via a display screen controlled by the client device 104). In practice, this communication may take the form of one or more messages (e.g., one or more HTTP messages) that are sent over the communication path 106 between the back-end computing platform 102 and the client device 104 and, in at least some implementations, the communication may be sent via one or more APIs.

The GUI, as updated in response to performance of the disclosed AI-based software technology, may take any of various forms. For example, the updated GUI may, after creation of the machine-learning model using the disclosed AI-based software technology, comprise a prompt for a user to provide an input dataset to by analyzed by the created machine-learning model. In another example, the updated GUI may comprise metrics related to performance of the created machine-learning model and/or results of validation testing of the machine-learning model (e.g., as performed by the risk-management crew 230). The updated GUI may take various other forms, as well, based on output of one or both of the modelling crew 220 or the risk-management crew 230.

The front-end interface 207 may perform other functions as well, including but not limited to the possibility that the front-end interface 207 may exchange other types of communications from the client devices 104 that do not involve prompts for creating machine-learning models.

Further, in other implementations, the front-end interface 207 may be configured to pass requests to and/or receive responses from other components of the AI-based software architecture 200, such as such as the orchestrator AI agent(s) 210 and/or the crews 220, 230.

The orchestrator AI agent(s) 210 may generally function to (i) utilize the generative AI model(s) 240 to decompose the request(s) to generate the machine-learning model into a set of modelling tasks, (ii) based on the set of modelling tasks, generate instructions for the set of modelling AI agents 222 of the modelling crew 220, (iii) pass the identifier for the dataset and the instructions for the set of modelling AI agents 222 to the set of modelling AI agents 222, and (iv) receive modelling output from the set of modelling AI agents 222.

In some examples, the orchestrator AI agent(s) 210 may, generally, further function to (i) utilize the generative AI model(s) 240 to decompose a request to validate a machine-learning model into a set of risk-management tasks, (ii) based on one or both of an input machine-learning model (which, in some examples, may have been generated as the modelling output), generate instructions for the set of risk-management AI agents 232 of the risk-management crew 230, (iii) pass the identifier for the dataset, the machine-learning model, and the instructions for the set of risk-management AI agents 232 to the set of risk-management AI agents 232, and (iv) receive risk-management output from the set of risk-management AI agents 232.

At a high level, the functionality of utilizing the generative AI model(s) 240 to decompose either (i) a request to generate a machine-learning model into the set of modelling tasks or (ii) a request to validate a machine-learning model into the set of risk-management tasks may involve generating a prompt for the generative AI model(s) 240 to decompose the respective request into the set of modelling tasks and/or the set of risk-management tasks.

In one example implementation, the function of generating the prompt for the generative AI model(s) 240 to decompose the request to generate the machine-learning model into the set of modelling tasks and/or decompose the request to validate a machine-learning model into the set of risk-management tasks may involve transforming the received request into a prompt for the generative AI model(s) 240, wherein the prompt for the generative AI model(s) 240 comprises (i) the request to create the machine-learning model, (ii) an instruction for the generative AI model(s) 240 to decompose the request into the set of modelling tasks and/or the set of risk-management tasks, and perhaps also (iii) additional data (e.g., role data, context data, etc.) that may be utilized by the generative AI model(s) 240 when performing the task of decomposing the request into the set of modelling tasks and/or the set of risk-management tasks. In this respect, the additional data that may be included in the prompt may take various forms.

For example, the additional data may include a given role associated with the orchestrator AI agent(s) 210 (e.g., a data science manager role) that the generative AI model(s) 240 may consider when functioning to decompose the request to create the machine-learning model into the set of modelling tasks and/or the set of risk-management tasks (e.g., information to decompose the request from the perspective of a data science manager tasked with providing instructions for other actors to create the machine-learning model). As another example, the additional data may include a particular goal (or set of goals) that the generative AI model(s) 240 may consider in decomposing the request to create and/or validate the machine-learning model into the set of modelling tasks and/or the set of risk-management tasks (e.g., a goal to decompose the request into no more than a given number of tasks, a goal to refrain from decomposing the request if the identified dataset is incomplete, among other possibilities). The additional data may take various other forms as well.

It should be understood that while the prompt may comprise such additional data that may be separate from the instruction for the prompt, in some implementations, the additional data may be included as part of the instruction itself. Further, the prompt may include other components and may take various other forms.

The function of generating the prompt for the generative AI model(s) 240 may also involve other operations. For example, in conjunction with transforming the request to create the machine-learning model into the prompt for the generative AI model(s) 240, the function of generating the prompt may involve performing data cleaning operations on the received request. The data cleaning operations may involve formatting the request to correct informalities, such as typographical and/or grammatical errors, linguistic inconsistencies, or the like. The function of generating the prompt for the generative AI model(s) 240 may take various other forms as well.

After the orchestrator AI agent(s) 210 generates the prompt, the orchestrator AI agent(s) 210 may provide that prompt to the generative AI model(s) 240. The generative AI model(s) 240 may in turn function to receive the prompt as input and decompose the received request into the set of modelling tasks and/or the set of risk-management tasks. This function of decomposing the received request into the set of modelling tasks and/or the set of risk-management tasks may take various forms.

As an example, decomposing the request to create the machine-learning model into the set of modelling tasks may involve the generative AI model(s) 240 carrying out any of various reasoning techniques to divide the request to create the machine-learning model into a set of modelling tasks that comprises one or more of an exploratory data analysis (EDA) task, a feature-engineering task, a model-selection task, a hyperparameter-tuning task, a model-training task, and a model-evaluation task. As another example, decomposing the request to validate the machine-learning model into the set of risk-management tasks may involve the generative AI model(s) 240 carrying out any of various reasoning techniques to divide the request to validate the machine-learning model into a set of risk-management tasks that comprises one or more of a model-validator task, a stress-test task, and a documentation task. Decomposing the request(s) to create and/or validate a machine-learning model into the set of modelling tasks and/or set of risk-management tasks, by the generative AI model(s), may take various other forms, as well.

As one possible implementation, decomposing the request to generate and/or validate the machine-learning model may involve generative AI model(s) 240 carrying out any of various types of chain-of-thought (or “CoT” for short) reasoning techniques (e.g., zero-shot CoT, automatic CoT, or the like) to divide the request into the set of modelling tasks and/or the set of risk-management tasks. In this regard, the disclosed architecture may leverage the chain-of-thought reasoning capabilities of the generative AI model(s) 240 model to divide the request into the set of modelling tasks and/or the set of risk-management tasks, where each of the set of modelling tasks and/or the set of risk-management tasks may be performed individually, and the collective output based on the set of modelling tasks and/or the set of risk-management tasks may be used to formulate modelling output and/or risk-management output.

The function of decomposing the request to generate and/or validate the machine-learning model into the set of modelling tasks and/or the set of risk-management tasks may also take other forms.

In practice, the orchestrator AI agent(s) 210 may pass the prompt to the generative AI model(s) 240 and receive the response from the generative AI model(s) 240, which may take any of various forms that may depend in part on where the generative AI model(s) 240 is hosted. For instance, in an implementation where the generative AI model(s) 240 is hosted on a separate computing platform from the back-end computing platform 102, these functions may involve sending the generated prompt to the generative AI model(s) 240 over an external network-based communication path (e.g., via an API or the like) and then receiving the response from the generative AI model(s) 240 over the external network-based communication path. Alternatively, in an implementation where the generative AI model(s) 240 is hosted on the back-end computing platform 102, these functions may involve sending the generated prompt via an internal communication path (e.g., an API, a messaging queue or bus, or some other form of inter-process communication) and then receiving the response from the generative AI model(s) 240 over the internal communication path. The functions the orchestrator AI agent(s) 210 performs to pass the generated prompt to the generative AI model(s) 240 and to receive the response from the generative AI model(s) 240 may take other forms as well.

The function of generating instructions for the set of modelling AI agents 222 and/or the set of risk-management AI agents 232, by the orchestrator AI agent(s) 210, may take any of various forms. For example, generating the instructions for the set of modelling AI agents 222 and/or the set of risk-management AI agents 232 may comprise determining routing instructions for each of the generated set of modelling tasks and/or risk-management tasks. The routing instructions may comprise an identification of an AI agent 222, 232 for which instructions for completing each of the generated set of modelling tasks and/or risk-management tasks is to be passed to.

In some examples, the functionality for generating instructions for the set of modelling AI agents 222 and/or the set of risk-management AI agents 232 may comprise updating the instructions for the set of modelling AI agents 222 and/or the set of risk-management AI agents 232. In some such examples, updating the instructions for the set of modelling AI agents 222 and/or the set of risk-management AI agents 232 may be based on modelling output and/or risk-management output.

In some other examples, updating the instructions for the set of modelling AI agents 222 and/or the set of risk-management AI agents 232 may be in response to human input (e.g., provided via the client device 104), such as via a “human-in-the-loop” function of the AI-based software architecture 200. Such a human-in-the-loop mechanism enables a user (who may be directing some functionality of the AI-based software architecture 200) to provide oversight and/or domain expertise to update parameters utilized by the AI agent(s) 210, 222, 232 based on the user’s observations of output during the modelling and/or risk management processes. Particularly, with respect to the modelling AI agents 222 and/or the risk management AI agents 232, if an AI agent 222, 232 performs a task that requires expertise of a user based on some condition (e.g., stakeholder needs, business needs, business assumptions, regulatory recommendations, etc.), that user may utilize the human-in-the-loop function to influence generation of a machine-learning model. Thus, the human-in-the-loop function enables a user to provide input, via the client device 104, which is then translated into prompts for given AI agent(s) 222, 232 to perform one or more of updating the initial prompt passed to individual AI agent(2) 222, 232 to address some business assumptions not captured in the original makeup of the initial prompt or to affirm an output of an AI agent 222, 232 is accurate. As a practical example, consider that a modelling AI agent 222 is a “feature-engineering agent” that decides if certain features/variables are to be excluded from input data based on some regulatory recommendations and/or business needs. In this example, the feature-engineering agent may not, initially, be familiar with these regulatory recommendations and/or business needs, and, thus, human insights are valuable in influencing the feature-engineering agent’s behavior. However, such human-in-the-loop functions may take any of various other forms.

Updating the instructions for the set of modelling AI agents 222 and/or the set of risk-management AI agents 232 may comprise repeating the functionality for decomposing the request to generate and/or validate the machine-learning model into a set of modelling tasks and/or the set of risk-management tasks, but with a prompt that includes one or both of the modelling output and the risk-management output. Updating the instructions for the set of modelling AI agents 222 and/or the set of risk-management AI agents 232 may take various other forms, as well.

The function of generating instructions for the set of modelling AI agents 222 and/or the set of risk-management AI agents 232 may take various other forms, as well.

The functions of passing the identifier for the dataset and/or machine-learning model and the instructions for the set of modelling AI agents 222 and/or the set of risk-management AI agents 232, respectively, to the set of modelling AI agents 222 and/or the set of risk-management AI agents 232 may take any of various forms. This functionality may involve sending the identifier(s) and the instructions for the set of modelling AI agents 222 and/or the set of risk-management AI agents 232, respectively, to the set of modelling AI agents 222 and/or the set of risk-management AI agents 232 via an API, a messaging queue or bus, or some other form of inter-process communication.

The functions of receiving the modelling output and/or the risk-management output, respectively, from the set of modelling AI agents 222 and/or the set of risk-management AI agents 232 may take any of various forms. This functionality may involve receiving the modelling output and/or the risk-management output, respectively, from the set of modelling AI agents 222 and/or the set of risk-management AI agents 232 via an API, a messaging queue or bus, or some other form of inter-process communication.

In some example implementations, the orchestrator AI agent(s) 210 may further function to store, to data storage, one or more of the modelling output, the risk-management output, and/or the machine-learning model. The stored one or more of the modelling output, the risk-management output, and/or the machine-learning model may then be accessed by any of the orchestrator AI agent(s) 210, the modelling AI agents 222, and the risk-management AI agents. Such storing may influence a “short-term memory” or “long-term memory” for the orchestrator AI agent(s) 210, which can influence decision-making, delegation, information retrieval, or any other functionality of the orchestrator AI agent(s) 210 (or downstream functionality of other AI agent(s) 222, 232).

Creating the machine-learning model, via the execution of various modelling tasks, may take any of various forms. For example, the orchestrator AI agent(s) 210 may be configured to create the machine-learning model based on modelling output received from the modelling crew 220. In this example, the modelling output may comprise modelling output (e.g., training data, hyperparameters, model-type, etc.) for the machine-learning model and the orchestrator AI agent(s) 210 may utilize the modelling output to generate a prompt for generative AI model(s) 240 to generate instructions for input to a function for generating the machine-learning model, based on the modelling output. Alternatively (and as will be discussed below), the machine-learning model may be created by the modelling crew 220 and passed to the orchestrator AI agent(s) 210. Creating the machine-learning model may take various other forms, as well.

In accordance with the present disclosure, the orchestrator AI agent(s) 210 may take the form of a software component that provides an interface to a respective AI model (e.g., the generative AI model(s) 240) and is preconfigured to perform particular AI-based functionality in order to accomplish a respective type of task that is preconfigured for the orchestrator AI agent(s) 210 – which in this case involves AI-based functionality for generating instructions for a set of modelling AI agents and/or a set of risk-management AI agents. In some implementations, the orchestrator AI agent(s) 210 may be implemented in the form of a discrete executable software component, which is how the orchestrator AI agent(s) 210 is shown in FIG. 2 and described for purposes of illustration. However, it should be understood that in other implementations, the orchestrator AI agent(s) 210 may be implemented in the form of a discrete configuration file (e.g., a YAML file) that, when loaded and executed by a centralized execution engine (e.g., an agent executor), causes the centralized execution engine to perform the functions for the orchestrator AI agent(s) 210. The orchestrator AI agent(s) 210 may take other forms as well.

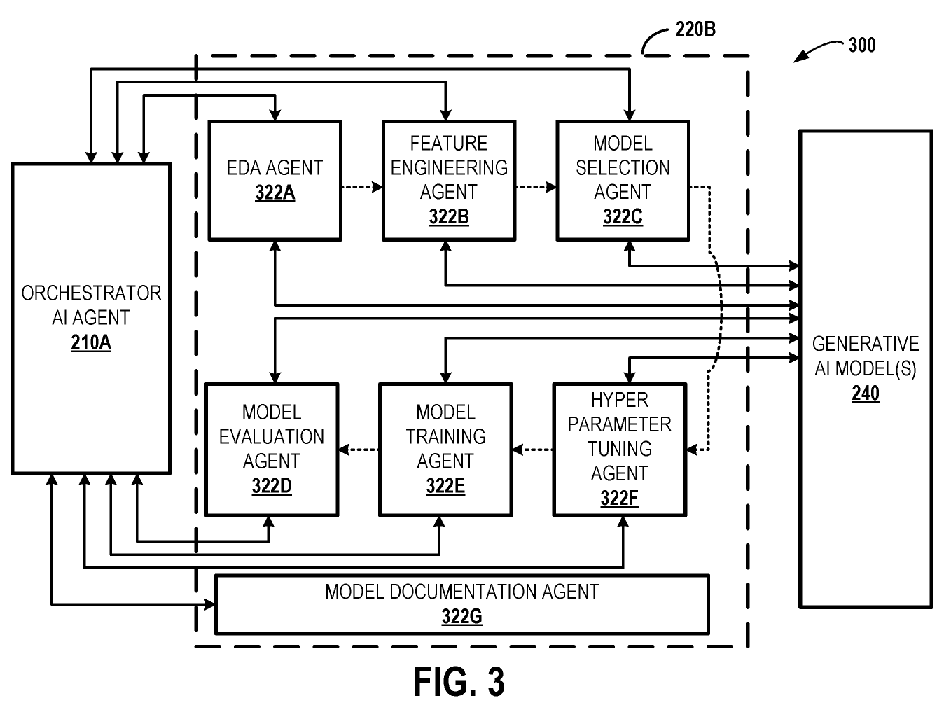

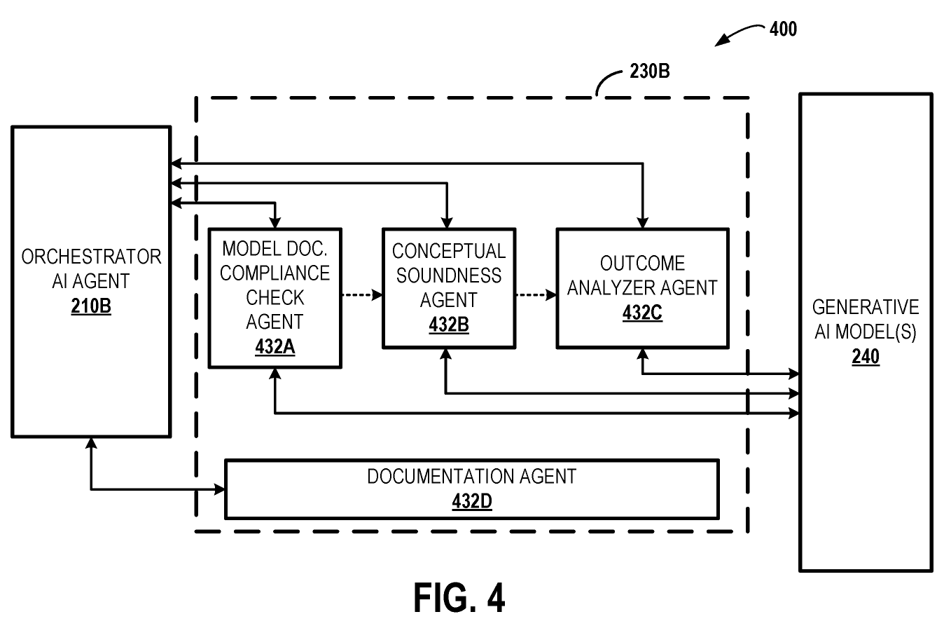

While the orchestrator AI agent(s) 210 are illustrated in FIG. 2 as a single component of the AI-based software architecture 200, it is contemplated that the AI-based software architecture 200 may include two or more orchestrator AI agent(s) 210 to perform management functionality with relation to the crews 220, 230. For example, the orchestrator AI agent(s) 210 may comprise (i) a first orchestrator AI agent 210A (e.g., as illustrated in FIG. 3) that is configured to manage the modelling crew 220 and (ii) a second orchestrator AI agent 210B (e.g., as illustrated in FIG. 4) that is configured to manage the risk-management crew 230. In such an example, the first orchestrator AI agent 210A may be configured to have a role parameter of a “Data Science Manager” and the second orchestrator AI agent 210B may be configured to have a role parameter of a “Model Risk Management Manager.” Orchestrator AI agent(s) 210 may take any of various other forms, as well.

After receiving instructions from the orchestrator AI agent(s) 210, each of the set of modelling AI agents 222 of the modelling crew 220 may then perform its respective functionality for generating the model output. The modelling crew 220 may comprise any number of AI agents 222A-N that each provide functionality for carrying out a respective modelling function corresponding with a modelling task. Each of the modelling AI agents 222 may pass and receive information to/from one or more of (i) the orchestrator AI agent(s) 210, (ii) one or more other modelling AI agents 222 of the modelling crew 220, and/or (iii) one or more risk-management AI agents 232 of the risk-management crew 230.

In general, each modelling AI agent 222 may function to utilize the generative AI model(s) 240 to, (i) based on respective instructions of the set of instructions, generate input to a respective modelling function of a set of modelling functions for the modelling AI agents 222, (ii) based on the input for the modeling function, carry out the respective modelling function thereby generating respective modelling output corresponding with the respective modelling task, and (iii) pass the modelling output that comprises the respective modelling output corresponding with the respective modelling task.

At a high level, the functionality of utilizing the generative AI model(s) 240 to generate input to a respective modelling function of a set of modelling functions for the modelling AI agents 222 may involve generating a prompt for the generative AI model(s) 240 to determine and generate input to a respective modelling function of a set of modelling functions for the modelling AI agents 222, based on the instructions and/or the dataset.

In one implementation, the function of generating the prompt for the generative AI model(s) 240 to determine and generate input to a respective modelling function of a set of modelling functions for the modelling AI agents 222 may involve transforming the received instructions for the respective modelling AI agent 222 into the prompt for the generative AI model(s) 240, wherein such a prompt may comprise (i) the instructions for the modelling AI agent 222 from the orchestrator AI agent(s) 210, (ii) a request to generate input to a respective modelling function for the modelling AI agent 222 based on the instructions, and perhaps also (iii) additional data (e.g., role data, context data, etc.) that may be utilized by the generative AI model(s) 240 when performing the task of generating input to a respective modelling function for the modelling AI agent 222 based on the instructions. In this respect, the additional data that may be included in the prompt may take various forms.

For example, the additional data may include a given role associated with a given modelling AI agent 222 (e.g., a data scientist role, a machine-learning engineer role, etc.) that the generative AI model(s) 240 may consider in generating input to the respective modelling function for the given modelling AI agent 222. As another example, the additional data may include a particular goal (or set of goals) that the generative AI model(s) 240 may consider in generating input to the respective modelling function for the given modelling AI agent 222. The additional data may take various other forms as well.

It should be understood that while the prompt may comprise such additional data that may be separate from the instructions for the modelling AI agents 222, in some implementations, the additional data may be included as part of the instruction itself. Further, the prompt may include other components and may take various other forms.

The function of generating the prompt for the generative AI model(s) 240 may also involve other operations. For example, in conjunction with transforming the instructions into the prompt for the generative AI model(s) 240, the function of generating the prompt may involve performing data cleaning operations on the instructions. The data cleaning operations may involve formatting the instructions to correct informalities, such as typographical and/or grammatical errors, linguistic inconsistencies, or the like. The function of generating the prompt for the generative AI model(s) 240, by the modelling AI agents 222, may take various other forms as well.

After the modelling AI agent 222 generates the prompt, the modelling AI agent 222 may provide that prompt to the generative AI model(s) 240. The generative AI model(s) 240 may in turn function to receive the prompt as input and generate input to the respective modelling function for the given modelling AI agent 222. This function of generating input to the respective modelling function for the given modelling AI agent 222 may take various forms.

As an example, generating input to the respective modelling function for the given modelling AI agent 222 may involve the generative AI model(s) 240 carrying out any of various reasoning techniques to generate input to the respective modelling function for the given modelling AI agent 222.

In one example, generating the input to the respective modelling function may comprise generating a function call for a respective modelling function of a modelling AI agent 222. In practice, a function call may be defined as instructions for a function or software tool to perform the function (e.g., to generate code for execution via a code execution tool). In general, a function call may include instructions for performing the function and values for any function arguments in which argument values are used to complete the function.

The function of generating input to the respective modelling function for the given modelling AI agent 222 may also take other forms.

In practice, the modelling AI agents 222 may pass the prompt to the generative AI model(s) 240 and receive the response from the generative AI model(s) 240, which may take any of various forms that may depend in part on where the generative AI model(s) 240 is hosted. For instance, in an implementation where the generative AI model(s) 240 is hosted on a separate computing platform from the back-end computing platform 102, these functions may involve sending the generated prompt to the generative AI model(s) 240 over an external network-based communication path (e.g., via an API or the like) and then receiving the response from the generative AI model(s) 240 over the external network-based communication path. Alternatively, in an implementation where the generative AI model(s) 240 is hosted on the back-end computing platform 102, these functions may involve sending the generated prompt via an internal communication path (e.g., an API, a messaging queue or bus, or some other form of inter-process communication) and then receiving the response from the generative AI model(s) 240 over the internal communication path. The functions that the modelling AI agents 222 perform to pass the generated prompt to the generative AI model(s) 240 and to receive the response from the generative AI model(s) 240 may take other forms as well.

Each of the respective modelling functions for each of the respective modelling AI agents 222 may take any of various forms for carrying out functionality associated with accomplishing a respective, associated task of the set of modelling tasks (as determined by the orchestrator AI agent(s) 210). These respective modelling functions may call upon other software components of (or associated with) the AI-based software architecture 200 (e.g., via a function call) or, alternatively, may be included in the functionality of a given modelling AI agent 222.

The functionality for carrying out the respective modelling function based on the input for the modeling function, and thereby generating respective modelling output corresponding with the respective modelling task may take various forms. For example, carrying out the respective modelling function may comprise carrying out a function call (that was generated by the generative AI model(s) 240) for the respective modelling function and thereby generating the modelling output corresponding with the respective modelling task. Alternatively, carrying out the respective modelling function may comprise carrying out the respective function by the respective modelling AI agent 222 based on the input (e.g., values, parameters, etc.) generated by the generative AI model(s) 240. Carrying out the respective modelling function may take various other forms, as well.

The functions of passing the modelling output that comprises the respective modelling output corresponding with the respective modelling task may take any of various forms. This functionality may involve sending the modelling output that comprises the respective modelling output corresponding with the respective modelling task via an API, a messaging queue or bus, or some other form of inter-process communication.

The modelling AI agents 222 may each receive respective instructions of the set of instructions and this functionality may take any of various forms. For example, this functionality may involve receiving respective instructions of the set of instructions from the orchestrator AI agent(s) 210 via an API, a messaging queue or bus, or some other form of inter-process communication. Other examples are also possible.

In some example implementations, the modelling AI agents 222 may further function to store one or more of the modelling output and/or the machine-learning model to data storage. The stored one or more of the modelling output and/or the machine-learning model may then be accessed by any of the orchestrator AI agent(s) 210, the modelling AI agents 222, and the risk-management AI agents 232.

Creating the machine-learning model, via the execution of various modelling tasks, may take any of various forms. For example, the modelling crew 220 (using one or more modelling AI agents 222) may be configured to create the machine-learning model based on modelling output generated by the modelling crew 220. In this example, the modelling output may comprise the machine-learning model.

In accordance with the present disclosure, the modelling AI agents 222 may each take the form of a software component that provides an interface to a respective AI model (e.g., the generative AI model(s) 240) and is preconfigured to perform particular AI-based functionality in order to accomplish a respective type of task that is preconfigured for each modelling AI agent – which in this case involves AI-based functionality for generating modelling output corresponding with a modelling task. In some implementations, each modelling AI agent 222 may be implemented in the form of a discrete executable software component, which is how each modelling AI agent 222 is shown in FIG. 2 and described for purposes of illustration. However, it should be understood that in other implementations, each modelling AI agent 222 may be implemented in the form of a discrete configuration file (e.g., a YAML file) that, when loaded and executed by a centralized execution engine (e.g., an agent executor), causes the centralized execution engine to perform the functions for each modelling AI agent 222. Each modelling AI agent 222 may take other forms as well.

Turning now to FIG. 3, an example block diagram 300 for an example modelling crew 220B, in accordance with the disclosed AI-based software technology, is illustrated. In practice, the example modelling crew 220B, for utilization within the AI-based software architecture 200 of FIG. 2, may be encoded in the form of program instructions that are executable by one or more processors of a computing platform, and for purposes of illustration, the modelling crew 220B is described as being installed on and executed by the back-end computing platform 102 of FIG. 1, but it should be understood that the example modelling crew 220B may be installed on and executed by any one or more computing platforms that are capable of performing the example operations of the modelling crew 220B. Further, it should be understood that the example modelling crew 220B is merely described in this manner for the sake of clarity and explanation and that the example operations may be implemented in various other manners, including the possibility that logical blocks may be added, removed, rearranged into different orders, combined into fewer blocks, and/or separated into additional blocks depending upon the particular example.

The modelling crew 220B includes specific modelling AI agents 322 that are each preconfigured to carry out modelling functions related to modelling tasks. In practice, each of the modelling AI agents 322 may perform similar functionality to the modelling AI agents 222 of FIG. 2, but with specific, defined modelling functions that each are configured for completing a task associated with the machine-learning model.

As illustrated, the example modelling crew 220B may comprise a set of modelling AI agents 322, such as an EDA agent 322A, a feature-engineering agent 322B, a model-selection agent 322C, a hyperparameter-tuning agent 322D, a model-training agent 322E, a model-evaluation agent 322F, and a model documentation agent 322G. However, the example modelling crew 220B may include any other modelling AI agents 322 that could be useful in the modelling process (e.g., a cost analysis AI agent, etc.).

The EDA agent 322A is configured to perform an EDA function on the dataset that is identified by the identifier for the dataset. The EDA function is configured to generate an exploratory data analysis of the dataset, which may be utilized by other modelling AI agents in creating the machine-learning model. EDA may be an approach to analyzing the dataset that comprises a summary of the main characteristics of the data set. In some examples, EDA may be performed to determine insights from the data, prior to creating a machine-learning model using the dataset, to assist in determining ideal parameters for the machine-learning model.

In some examples, the EDA agent 322A may have a defined role, such as a “Senior Data Scientist” role. However, the EDA agent 322A may be assigned various other roles.

The EDA agent 322A may utilize an EDA tool to execute the EDA function, which may be software (either of the EDA agent 322A or called by the EDA agent 322A) for performing EDA on the dataset.

The EDA agent 322A may function to, (i) based on respective instructions of a set of modelling instructions provided to the modelling crew 220B by the orchestrator AI agent 210A and the dataset, utilize the generative AI model(s) 240 to generate input to the EDA function to carry out an exploratory data analysis on the dataset, (ii) based on the generated input to the EDA function, carry out the EDA function thereby generating the exploratory data analysis on the dataset, and (iii) pass the exploratory data analysis on the dataset to either another of the modelling AI agents 322 or the orchestrator AI agent 210A. The exploratory data analysis may comprise a portion of the modelling output and may be stored in data storage by either the EDA agent 322A and/or the orchestrator AI agent 210A.

In some examples, the exploratory data analysis output by the EDA agent 322A may be utilized by the feature-engineering agent 322B. The feature-engineering agent 322B may receive the exploratory data analysis by one of (i) receiving the exploratory data analysis output directly from the EDA agent 322A, (ii) receiving the exploratory data analysis output from the orchestrator AI agent 210A, or (iii) accessing the exploratory data analysis from data storage.

The feature-engineering agent 322B is configured to perform a feature-engineering function on the dataset. The feature-engineering function is configured to transform the dataset for use by the model-selection agent 322C and/or other agents of the modelling crew 220B. The feature-engineering function may function to refine the dataset into the transformed data set by normalizing abnormalities in the dataset (e.g., missing values for variables, incomplete categorical variables, class imbalance in the dataset, etc.). This functionality may utilize various feature-engineering techniques, such as, but not limited to K-Nearest Neighbors (KNN) imputation, label encoding, Synthetic Minority Oversampling Technique (SMOTE), etc. Further still, the feature-engineering functionality of the feature-engineering agent 322B may, additionally or alternatively, include generating various combinations of features using concatenation functions and/or other transformations such as logarithmic, polynomial, mean, median, year over year change, averages over various time intervals etc. Such functionality may be based on automated pre-defined rules, human in the loop input, and/or access to an LLM based prompt from the orchestrator AI agent 210A, for feature engineering specifically

In some examples, the feature-engineering agent 322B may have a defined role, such as a “Senior Data Scientist” role. However, the feature-engineering agent 322B may be assigned various other roles.

The feature-engineering agent 322B may utilize a code-execution tool to execute the feature-engineering function, which may be software (either of the feature-engineering agent 322B or called by the feature-engineering agent 322B) that executes code for performing the feature-engineering function. This code may be generated, for example, by the generative AI model(s) 240 in response to a prompt from the feature-engineering agent 322B.

The feature-engineering agent 322B may function to, (i) based on respective instructions of a set of modelling instructions provided to the modelling crew 220B by the orchestrator AI agent 210A and the dataset, utilize the generative AI model(s) 240 to generate input to the feature-engineering function to carry out the feature-engineering function, (ii) based on the generated input to the feature-engineering function, carry out the feature-engineering function thereby generating the transformed dataset, and (iii) pass the transformed dataset to either another of the modelling AI agents 322 or the orchestrator AI agent 210A. The transformed dataset may comprise a portion of the modelling output and may be stored in data storage by either the feature-engineering agent 322B or the orchestrator AI agent 210A. In some examples, the feature-engineering agent 322B may provide the generative AI model(s) 240 with the exploratory data analysis, as input, and the generated input to the feature-engineering function is further based on the exploratory data analysis.

In some examples, the transformed dataset output by the feature-engineering agent 322B may be utilized by the model-selection agent 322C. The model-selection agent 322C may receive the transformed dataset by one of (i) receiving the transformed dataset output directly from the feature-engineering agent 322B, (ii) receiving the transformed dataset output from the orchestrator AI agent 210A, or (iii) accessing the transformed dataset from data storage.

While described as performing its functionality using the transformed dataset output by the feature-engineering agent 322B, it is also contemplated that the model-selection agent 322C may carry out the foregoing functionality utilizing the dataset in its original form, and/or combinations thereof.

The model-selection agent 322C is configured to perform a model-selection function on the transformed dataset. The model-selection function is configured to select a suitable type of model (e.g., suitable algorithm(s)) for the machine-learning model, based on the transformed dataset and in response to the instructions from the orchestrator AI agent 210A. In some examples, the model-selection function is configured to select the type of model for the machine-learning model, further based on the exploratory data analysis.

The output type of model selected via the model-selection function may take any of various forms. For example, the output type of model selected via the model-selection function may be selected from a set of reference types of machine-learning models which may comprise one or more of a linear regression type of machine-learning model, a logistic regression type of machine-learning model, a decision tree type of machine-learning model, a support vector machine (SVM) type of machine-learning model, a Bayes type of machine-learning model, a KNN type of machine-learning model, a K-means type of machine-learning model, a random forest type of machine-learning model, an XGBoost type of machine-learning model, a CatBoost type of machine-learning model, a zero-shot learning (ZSL) type of machine-learning model, or combinations thereof.

In some examples, the model-selection agent 322C may have a defined role, such as a “Senior Data Scientist” role. However, the model-selection agent 322C may be assigned various other roles, such as “Machine Learning Engineer.”

The model-selection agent 322C may utilize a code-execution tool to execute the model-selection function, which may be software (either of the model-selection agent 322C or called by the model-selection agent 322C) that executes code for performing the model-selection function. This code may be generated, for example, by the generative AI model(s) in response to a prompt from the model-selection agent 322C.

The model-selection agent 322C may function to, (i) based on respective instructions of a set of modelling instructions provided to the modelling crew 220B by the orchestrator AI agent 210A and the transformed dataset, utilize the generative AI model(s) 240 to generate input to the model-selection function to carry out the model-selection function, (ii) based on the generated input to the model-selection function, carry out the model-selection function thereby selecting a type of model from a reference set of types of machine-learning models, and (iii) pass the type from the reference set of types of machine-learning models to either another of the modelling AI agents 322 or the orchestrator AI agent 210A. The type of model from the reference set of types of machine-learning models may comprise a portion of the modelling output and may be stored in data storage by either the model-selection agent 322C or the orchestrator AI agent 210A.

With the type of model for the machine-learning model selected, the hyperparameter-tuning agent 322D may be utilized for hyperparameter-tuning of the selected type of model. The hyperparameter-tuning agent 322D may receive the type for the machine-learning model by one of (i) receiving the type for the machine-learning model output directly from the hyperparameter-tuning agent 322D, (ii) receiving the type for the machine-learning model as output from the orchestrator AI agent 210A, or (iii) accessing the type for the machine-learning model from data storage.

The hyperparameter-tuning agent 322D is configured to perform a hyperparameter-tuning function for the machine-learning model based on the type for the machine-learning model. The hyperparameter-tuning function is configured to select suitable hyperparameters for the machine-learning model, based on the type for the machine-learning model and in response to the instructions from the orchestrator AI agent 210A. The hyperparameter-tuning function may utilize any of various hyperparameter-tuning techniques (or sometimes referred to as “hyperparameter optimization” techniques), including but not limited to a grid search, Bayesian search, and/or randomized search technique, among other possible as examples.

In some examples, the hyperparameter-tuning agent 322D may have a defined role, such as a “Senior Data Scientist” and/or “Machine-Learning Engineer” role. However, the hyperparameter-tuning agent 322D may be assigned various other roles.

The hyperparameter-tuning agent 322D may utilize a code-execution tool to execute the hyperparameter-tuning function, which may be software (either of the hyperparameter-tuning agent 322D or called by hyperparameter-tuning agent 322D) that executes code for performing the hyperparameter-tuning function. This code may be generated, for example, by the generative AI model(s) in response to a prompt from the hyperparameter-tuning agent 322D.

The hyperparameter-tuning agent 322D may function to, (i) based on respective instructions of a set of modelling instructions provided to the modelling crew 220B by the orchestrator AI agent 210A and the type for the machine learning model, utilize the generative AI model(s) 240 to generate input to the hyperparameter-tuning function to carry out the hyperparameter-tuning function, (ii) based on the generated input to the hyperparameter-tuning function, carry out the hyperparameter-tuning function thereby selecting tuned hyperparameters, and (iii) pass the tuned hyperparameters to either another of the modelling AI agents 322 or the orchestrator AI agent 210A. The tuned hyperparameters may comprise a portion of the modelling output and may be stored in data storage by either the hyperparameter-tuning agent 322D or the orchestrator AI agent 210A.

With the type for the machine-learning model selected and the hyperparameters tuned, the model-training agent 322E may be utilized for training of the machine-learning model.

The model-training agent 322E is configured to train the machine-learning model. The model-training function is configured to obtain the training data for the machine-learning model and train the machine-learning model, in response to the instructions from the orchestrator AI agent 210A. The model-training function may utilize any of various training techniques including but not limited to splitting the input data between training and test datasets (e.g. using an “80/20 rule” split).

In some examples, the model-training agent 322E may have a defined role, such as a “Senior Machine-Learning Engineer” role. However, the model-training agent 322E may be assigned various other roles.

The model-training agent 322E may utilize a code-execution tool to execute the model-training function, which may be software (either of the model-training agent 322E or called by the model-training agent 322E) that executes code for performing the model-training function. This code may be generated, for example, by the generative AI model(s) 240 in response to a prompt from the model-training agent 322E.

The model-training agent 322E may function to, (i) based on respective instructions of a set of modelling instructions provided to the modelling crew 220B by the orchestrator AI agent 210A, utilize the generative AI model(s) 240 to generate input to the model-training function to carry out the model-training tuning function, (ii) based on the generated input to the model-training tuning function, carry out the model-training function thereby train and create the machine-learning model, and (iii) pass the trained machine-learning model to either another of the modelling AI agents 322 or the orchestrator AI agent 210A. The machine-learning model generated using the model-training function may comprise a portion of the modelling output and may be stored in data storage by either the model-training agent 322E or the orchestrator AI agent 210A.

The model-evaluation agent 322F is configured to evaluate the machine-learning model using test data output by the model-training agent 322E (e.g., the portion of the input data that was not used to train the machine-learning model). The model-evaluation function is configured to generate performance data for the machine-learning model (e.g., accuracy, F1-score, precision score, recall score, etc.) based on the test data, in response to the instructions from the orchestrator AI agent 210A.

In some examples, the model-evaluation agent 322F may have a defined role, such as a “Senior Machine-Learning Engineer” role. However, the model-evaluation agent 322F may be assigned various other roles.

The model-evaluation agent 322F may utilize a code-execution tool to execute the model-evaluation function, which may be software (either of the model-evaluation agent 322F or called by the model-evaluation agent 322F) that executes code for performing the model-evaluation function. This code may be generated, for example, by the generative AI model(s) 240 in response to a prompt from the model-evaluation agent 322F.

The model-evaluation agent 322F may function to, (i) based on respective instructions of a set of modelling instructions provided to the modelling crew 220B by the orchestrator AI agent 210A, utilize the generative AI model(s) 240 to generate input to the model-evaluation function to carry out the model-evaluation function, (ii) based on the generated input to the model-evaluation function, carry out the model-evaluation function thereby generating performance data for the machine-learning model, and (iii) pass the performance data to either another of the modelling AI agents 322 or the orchestrator AI agent 210A. The performance data may comprise a portion of the modelling output and may be stored in data storage by either the model-evaluation agent 322F or the orchestrator AI agent 210A.

The model documentation agent 322G is configured to document, in plain text, technical documentation regarding one or more tasks performed by any of the AI agents 222, 322 of the AI-based software architecture 200. A documentation function is configured to generate documentation for the machine-learning model based on execution of the documentation function, in response to the instructions from the orchestrator AI agent 210A.

In some examples, the model documentation agent 322G may have a defined role, such as a “Secretary or Technical writer” role. However, the model documentation agent 322G may be assigned various other roles.

The model documentation agent 322G may utilize a code-execution tool to execute its various functions, which may be software (either of the model documentation agent 322G or called by the model documentation agent 322G) that executes code for performing the documentation function. This code may be generated, for example, by the generative AI model(s) 240 in response to a prompt from the model documentation agent 322G.

The model documentation agent 322G may function to, (i) based on respective instructions of a set of modeling instructions provided to the modeling crew 220B by the orchestrator AI agent 210A, utilize the generative AI model(s) 240 to generate input to the documentation function to carry out the documentation function, (ii) based on the generated input to the documentation function, carry out the documentation function thereby generating documentation for the machine-learning model, and (iii) pass the documentation to either another of the modeling AI agents 322 or the orchestrator AI agent 210A. The documentation may comprise a portion of the modeling output and may be stored in data storage by either the model documentation agent 322G or the orchestrator AI agent 210A.

The modelling AI agents 322 of FIG. 3 are only one example of a set of modelling AI agents that may be utilized in accordance with the disclosed AI-based software technology. Modelling AI agents may take various other forms.

Returning again to FIG. 2, after receiving instructions from the orchestrator AI agent(s) 210, each of the set of risk-management AI agents 232 of the risk-management crew 230 may then perform its respective functionality for generating the risk-management output. The risk-management crew 230 may comprise any number of risk-management AI agents 232A-N that each provide functionality for carrying out a respective risk-management function corresponding with a risk-management task. Each of the risk-management AI agents 232 may pass and receive information to/from one or more of (i) the orchestrator AI agent(s) 210, (ii) one or more other risk-management AI agents 232 of the risk-management crew 230, and/or (iii) one or more modelling AI agents 222 of the modelling crew 220.

In general, each risk-management AI agent 232 may function to utilize the generative AI model(s) 240 to, (i) based on respective instructions of the set of instructions, generate input to a respective risk-management function of a set of risk-management functions for the risk-management AI agents 232, (ii) based on the input for the risk-management function, carry out the respective risk-management function thereby generating respective risk-management output corresponding with the respective risk-management task, and (iii) pass the risk-management output that comprises the respective risk-management output corresponding with the respective risk-management task.

At a high level, the functionality of utilizing the generative AI model(s) 240 to generate input to a respective risk-management function of a set of risk-management functions for the risk-management AI agents 232 may involve generating a prompt for the generative AI model(s) 240 to determine and generate input to a respective risk-management function of a set of risk-management functions for the risk-management AI agents 232, based on the instructions and/or a machine-learning model.

In one implementation, the function of generating the prompt for the generative AI model(s) 240 to determine and generate input to a respective risk-management function of a set of risk-management functions for the risk-management AI agents 232 may involve transforming the received instructions for the respective risk-management AI agent 232 into the prompt for the generative AI model(s) 240, wherein such a prompt may comprise (i) the instructions for the risk-management AI agent 232 from the orchestrator AI agent(s) 210, (ii) a request to generate input to a respective risk-management function for the risk-management AI agent 232 based on the instructions, and perhaps also (iii) additional data (e.g., role data, context data, etc.) that may be utilized by the generative AI model(s) 240 when performing the task of generating input to a respective risk-management function for the risk-management AI agent 232 based on the instructions. In this respect, the additional data that may be included in the prompt may take various forms.

For example, the additional data may include a given role associated with a given risk-management AI agent 232 (e.g., a data scientist role, a machine-learning engineer role, etc.) that the generative AI model(s) 240 may consider in generating input to the respective modelling function for the given risk-management AI agent 232. As another example, the additional data may include a particular goal (or set of goals) that the generative AI model(s) 240 may consider in generating input to the respective risk-management function for the given risk-management AI agent 232. The additional data may take various other forms as well.

It should be understood that while the prompt may comprise such additional data that may be separate from the instructions for the risk-management AI agent 232, in some implementations, the additional data may be included as part of the instruction itself. Further, the prompt may include other components and may take various other forms.

The function of generating the prompt for the generative AI model(s) 240 may also involve other operations. For example, in conjunction with transforming the instructions into the prompt for the generative AI model(s) 240, the function of generating the prompt may involve performing data cleaning operations on the instructions. The data cleaning operations may involve formatting the instructions to correct informalities, such as typographical and/or grammatical errors, linguistic inconsistencies, or the like. The function of generating the prompt for the generative AI model(s) 240, by the risk-management AI agents 232, may take various other forms as well.

After the risk-management AI agent 232 generates the prompt, the risk-management AI agent 232 may provide that prompt to the generative AI model(s) 240. The generative AI model(s) 240 may in turn function to receive the prompt as input and generate input to the respective modelling function for the given risk-management AI agent 232. This function of generating input to the respective risk-management function for the given risk-management AI agent 232 may take various forms.

As an example, generating input to the respective risk-management function for the given risk-management AI agent 232 may involve the generative AI model(s) 240 carrying out any of various reasoning techniques to generate input to the respective modelling function for the given risk-management AI agent 232.

In one example, generating the input to the respective risk-management function may comprise generating a function call for a respective risk-management function of a risk-management AI agent 232. In practice, a function call may be defined as instructions for a function or software tool to perform the function (e.g., generated code for execution via a code execution tool). In general, a function call may include instructions for performing the function and function arguments in which argument values are used to complete the function.

The function of generating input to the respective risk-management function for the given risk-management AI agent 232 may also take other forms.

In practice, the risk-management AI agents 232 may pass the prompt to the generative AI model(s) 240 and receive the response from the generative AI model(s) 240, which may take any of various forms that may depend in part on where the generative AI model(s) 240 is hosted. For instance, in an implementation where the generative AI model(s) 240 is hosted on a separate computing platform from the back-end computing platform 102, these functions may involve sending the generated prompt to the generative AI model(s) 240 over an external network-based communication path (e.g., via an API or the like) and then receiving the response from the generative AI model(s) 240 over the external network-based communication path. Alternatively, in an implementation where the generative AI model(s) 240 is hosted on the back-end computing platform 102, these functions may involve sending the generated prompt via an internal communication path (e.g., an API, a messaging queue or bus, or some other form of inter-process communication) and then receiving the response from the generative AI model(s) 240 over the internal communication path. The functions that the risk-management AI agents 232 perform to pass the generated prompt to the generative AI model(s) 240 and to receive the response from the generative AI model(s) 240 may take other forms as well.

Each of the respective risk-management functions for each of the respective risk-management AI agents 232 may take any of various forms for carrying out functionality associated with accomplishing a respective, associated task of the set of risk-management tasks (as determined by the orchestrator AI agent(s) 210). These respective risk-management functions may call upon other software components of (or associated with) the AI-based software architecture 200 (e.g., via a function call) or, alternatively, may be included in the functionality of a given risk-management AI agent 232.

The functionality for carrying out the respective risk-management function based on the input for the risk-management function may take any of various forms. For example, carrying out the respective risk-management function may comprise carrying out a function call (that was generated by the generative AI model(s) 240) for the respective risk-management function and thereby generating the risk-management output corresponding with the respective risk-management task. Alternatively, carrying out the respective risk-management function may comprise carrying out the respective function by the respective risk-management AI agent 232 based on the input (e.g., values, parameters, etc.) generated by the generative AI model(s) 240. Carrying out the respective risk-management function may take various other forms, as well.

The functions of passing the risk-management output that comprises the respective risk-management output corresponding to the respective risk-management task may take any of various forms. This functionality may involve sending the risk-management output that comprises the respective risk-management output corresponding with the respective modelling task via an API, a messaging queue or bus, or some other form of inter-process communication.

The risk-management AI agents 232 may each function based on receiving respective instructions of the set of instructions and this functionality may take any of various forms. This functionality may involve receiving respective instructions of the set of instructions from the orchestrator AI agent(s) 210 via an API, a messaging queue or bus, or some other form of inter-process communication.

In some example implementations, the risk-management AI agents 232 may further function to store the risk-management output to data storage. The stored risk-management output may then be accessed by any of the orchestrator AI agent(s) 210, the modelling AI agents 222, and the risk-management AI agents 232.

In accordance with the present disclosure, the risk-management AI agents 232 may each take the form of a software component that provides an interface to a respective AI model (e.g., the generative AI model(s) 240) and is preconfigured to perform particular AI-based functionality in order to accomplish a respective type of task that is preconfigured for each risk-management AI agent – which in this case involves AI-based functionality for generating risk-management output corresponding with a risk-management task. In some implementations, each risk-management AI agent 232 may be implemented in the form of a discrete executable software component, which is how each risk-management AI agent 232 is shown in FIG. 2 and described for purposes of illustration. However, it should be understood that in other implementations, each risk-management AI agent 232 may be implemented in the form of a discrete configuration file (e.g., a YAML file) that, when loaded and executed by a centralized execution engine (e.g., an agent executor), causes the centralized execution engine to perform the functions for each risk-management AI agent 232. Each risk-management AI agent 232 may take other forms as well.

Turning now to FIG. 4, an example block diagram 400 for an example risk-management crew 230B, in accordance with the disclosed AI-based software technology, is illustrated. In practice, the example risk-management crew 230B, for utilization within the AI-based software architecture 200 of FIG. 2, may be encoded in the form of program instructions that are executable by one or more processors of a computing platform, and for purposes of illustration, the risk-management crew 230B is described as being installed on and executed by the back-end computing platform 102 of FIG. 1, but it should be understood that the example risk-management crew 230B may be installed on and executed by any one or more computing platforms that are capable of performing the example operations of the risk-management crew 230B. Further, it should be understood that the example risk-management crew 230B is merely described in this manner for the sake of clarity and explanation and that the example operations may be implemented in various other manners, including the possibility that logical blocks may be added, removed, rearranged into different orders, combined into fewer blocks, and/or separated into additional blocks depending upon the particular example.

The risk-management crew 230B includes specific risk-management AI agents 432 that are each preconfigured to carry out risk-management functions related to risk-management tasks. In practice, each of the risk-management agents 432 may perform similar functionality to the risk-management AI agents 232 of FIG. 2, but for one or more defined risk-management functions.

As illustrated, the example risk-management crew 230B may comprise a set of risk-management agents 432, such as a model documentation compliance check agent 432A, a conceptual-soundness agent 432B, an outcome-analyzer agent 432C, and a model-risk-management documentation agent 432D. However, the example risk-management crew 230B may include any other risk-management AI agents 432 that could be useful in the risk-management process (e.g., a model oversight agent, a model governance agent, etc.).

The model documentation compliance check agent 432A is configured to verify that modeling documentation (associated with an input machine-learning model) is in line with the organizational procedure for training and/or developing machine learning models. In this regard, the function may utilize a search function (such as, for example, Retrieval Augmented Generation (RAG)) to read modeling documentation and compare it with an organization’s model documentation checklist and model development procedure documents. Based on this comparison, the model documentation compliance check agent 432A may then determine if a model (e.g., one created by the modelling crew(s) 220) followed the organization’s procedures. These functions may be performed in response to instructions from the orchestrator AI agent 210B.

In some examples, the model documentation compliance check agent 432A may have a defined role, such as a “Senior Data Scientist” role. However, the model documentation compliance check agent 432A may be assigned various other roles. The model documentation compliance check agent 432A may utilize a RAG tool to execute the function, which may be software (either of the model documentation compliance check agent 432A or called by the model documentation compliance check agent 432A) that probes the organization’s model documentation with findings from the modeling documentation on procedural efficiencies. This probing and/or verification may be generated, for example, by the generative AI model(s) 240 in response to a prompt from the model documentation compliance check agent 432A.

The model documentation compliance check agent 432A may function to, (i) based on respective instructions of a set of risk-management instructions provided to the risk-management crew 230B by the orchestrator AI agent 210B, utilize the generative AI model(s) 240 to generate input to the modelling compliance function to carry out procedural compliance check function, (ii) based on the generated input to the modelling compliance function, carry out the compliance function thereby probing the organizational blueprint with its findings from the modelling crew, and (iii) pass the findings to either another of the risk-management AI agents 432 or the orchestrator AI agent 210B. The findings may comprise a portion of the risk management output and may be stored in data storage by either the model documentation compliance check agent 432A or the orchestrator AI agent 210B.

The conceptual-soundness agent 432B is configured to test the machine-learning model to validate business and/or statistical assumptions related to an input model, interpretability, and compliance of the machine-learning model with applicable laws (e.g., laws governing fair lending procedures). In this regard, the conceptual-soundness function is configured to generate validation data for the selected machine-learning model based on execution of the conceptual-soundness function, in response to the instructions from the orchestrator AI agent 210B.

In some examples, the conceptual-soundness agent 432B may have a defined role, such as a “Senior Data Scientist” role. However, the conceptual-soundness agent 432B may be assigned various other roles.

The conceptual-soundness agent 432B may utilize a code-execution tool to execute the conceptual-soundness function, which may be software (either of the conceptual-soundness agent 432B or called by the conceptual-soundness agent 432B) that executes code for performing the conceptual-soundness function. This code may be generated, for example, by the generative AI model(s) 240 in response to a prompt from the conceptual-soundness agent 432B.

The conceptual-soundness agent 432B may function to, (i) based on respective instructions of a set of risk-management instructions provided to the risk-management crew 230B by the orchestrator AI agent 210B, utilize the generative AI model(s) 240 to generate input to the conceptual-soundness function to carry out the model-validator function, (ii) based on the generated input to the conceptual-soundness function, carry out the conceptual-soundness function thereby generating and/or using validation data for the machine-learning model, and (iii) pass the validation data to either another of the risk-management AI agents 432 or the orchestrator AI agent 210B. The validation data may comprise a portion of the risk management output and may be stored in data storage by either the conceptual-soundness agent 432B or the orchestrator AI agent 210B.

The outcome-analyzer agent 432C is configured to test the machine-learning model under extreme scenarios to evaluate robustness of the machine-learning models in addition to independently evaluating the performance metrics of the machine learning models and comparing to relevant performance benchmarks (e.g., accuracy, precision, recall, F1-score, top capture rates, confusion matrix, ROC (Receiver Operating Characteristic) curve, area under the curve (AUC), mean squared error (MSE), and mean absolute error (MAE) etc.). Such extreme scenarios can be simulated by using data perturbations (e.g., outliers and/or adversarial inputs) to validate the strength of the model under unknown conditions. Such inputs are synthetically generated to mirror what the original input should look like, but with a randomization function shifting the new data to the outlier block of the original data distribution. These kinds of inputs put heavy stress on the model, making sure that the model is strong enough to withstand adversarial attacks.

An outcome analyzer function is configured to generate stress-test data for the machine-learning model based on execution of the stress-test function, in response to the instructions from the orchestrator AI agent 210B.

In some examples, the outcome-analyzer agent 432C may have a defined role, such as a “Senior Data Scientist” role. However, the outcome-analyzer agent 432C may be assigned various other roles.

The outcome-analyzer agent 432C may utilize a code-execution tool to execute the outcome analyzer function, which may be software (either of the outcome-analyzer agent 432C or called by the outcome-analyzer agent 432C) that executes code for performing the outcome analyzer function. This code may be generated, for example, by the generative AI model(s) 240 in response to a prompt from the outcome-analyzer agent 432C.

The outcome-analyzer agent 432C may function to, (i) based on respective instructions of a set of risk-management instructions provided to the risk-management crew 230B by the orchestrator AI agent 210B, utilize the generative AI model(s) 240 to generate input to the outcome analyzer function to carry out the outcome analyzer function, (ii) based on the generated input to the outcome analyzer function, carry out the outcome analyzer function thereby generating outcome analyzer data for the machine-learning model, and (iii) pass the outcome analyzer data to either another of the risk-management AI agents 432 or the orchestrator AI agent 210B. The outcome analyzer data may comprise a portion of the risk management output and may be stored in data storage by either the outcome-analyzer agent 432C or the orchestrator AI agent 210B.

The model-risk-management documentation agent 432D is configured to document, in plain text, technical documentation regarding one or more tasks performed by any of the AI agents 232, 432 of the AI-based software architecture. A documentation function is configured to generate documentation for the machine-learning model based on execution of the documentation function, in response to the instructions from the orchestrator AI agent 210B.

In some examples, the model-risk-management documentation agent 432D may have a defined role, such as a “Secretary” or “Technical Writer” role. However, the model-risk-management documentation agent 432D may be assigned various other roles.

The model-risk-management documentation agent 432D may utilize a code-execution tool to execute the documentation function, which may be software (either of the model-risk-management documentation agent 432D or called by the model-risk-management documentation agent 432D) that executes code for performing the documentation function. This code may be generated, for example, by the generative AI model(s) 240 in response to a prompt from the model-risk-management documentation agent 432D.

The model-risk-management documentation agent 432D may function to, (i) based on respective instructions of a set of risk-management instructions provided to the risk-management crew 230B by the orchestrator AI agent 210B, utilize the generative AI model(s) 240 to generate input to the model-risk-management documentation function to carry out the documentation function, (ii) based on the generated input to the model-risk-management documentation function, carry out the model-risk-management documentation function thereby generating documentation for the machine-learning model, and (iii) pass the documentation to either another of the risk-management AI agents 432 or the orchestrator AI agent 210B. The documentation may comprise a portion of the risk management output and may be stored in data storage by either the model-risk-management documentation agent 432D or the orchestrator AI agent 210B.

The risk-management AI agents 432 of FIG. 4 are only one example of risk-management agents that may be utilized in accordance with the disclosed AI-based software technology. Risk-management AI agents may take various other forms.

Turning next to the generative AI model(s) 240 of FIGS. 2-4, in line with the discussion above, the generative AI model(s) 240 may generally function to (i) receive a prompt comprising a request to perform a task, (ii) perform the task, (iii) generate a response to the request that indicates the results of performing the task, and (iv) return the response to the software component from which the prompt was received.

For instance, as discussed above, the generative AI model(s) 240 may (i) receive a prompt from an AI agent comprising a request to generate a response based on a task for the AI agent that is based on the role for of the AI agent, (ii) generate a response to the prompt comprising input to a respective modelling function corresponding to a respective modelling task for the AI agent, and (iii) return the response to the AI agent.

The generative AI model(s) 240 may receive various other types of requests and perform various other tasks as well.

The generative AI model(s) 240 may take any of various forms. For instance, the generative AI model(s) 240 may be a transformer-based model (e.g., a language model such as a large language model (LLM) and/or a multimodal model such as a vision-language model (VLM)), a diffusion model, a model based on a generational adversarial network (GAN), and/or a model based on a variational autoencoders (VAEs), among other possible types of generative AI models. Further, the generative AI model(s) 240 may comprise a pre-trained generative AI model (e.g., an “off-the-shelf” generative AI model) that may or may not be further trained (e.g., via fine tuning, few-shot learning, or the like), or may comprise a generative AI model that is trained in the first instance to perform the tasks described herein, among other possibilities. Some representative examples of pre-trained generative AI models include a generative pre-trained transformer (GPT) type of generative AI model, a bidirectional encoder representations from transformers (BERT) type of generative AI model, a bidirectional auto-regressive transformer (BART) type of generative AI model, a text-to-text transfer transformer (T5) type of generative AI model, a pre-training with extracted gap sentences for abstractive summarization (PEGASUS) type of generative AI model, a large language model meta AI (LlaMA) type of generative AI model, a Phi-2 or Phi-3 type of generative AI model, a PaliGemma type of generative AI model, and/or a Florence-2 type of generative AI model, among other examples. The generative AI model(s) 240 may take other forms as well.

As discussed above, in some implementations, the generative AI model(s) 240 may be hosted on a computing platform that is separate from the back-end computing platform 102, in which case the generative AI model(s) 240 may be accessed over a network-based communication path (e.g., via an API or the like), while in other implementations, the generative AI model(s) 240 may be hosted on the back-end computing platform 102.

It should also be understood that the components of the example AI-based software architecture 200 could interface with multiple different generative AI model(s) 240. For instance, as one possibility, different components of the example AI-based software architecture 200 could be configured to interface with multiple different generative AI model(s) 240, which could be of the same type or of different types. As another possibility, the AI agent(s) 210, 222, 232 could be configured to interface with multiple different generative AI model(s) 240, which could be of the same type or of different types. Other configurations are possible as well.

The example AI-based software architecture 200 may take various other forms as well. For instance, as one possibility, the example AI-based software architecture 200 may include other components that are not shown or described above but may nevertheless facilitate the functionality disclosed herein. As another possibility, certain of the components shown and described above could be combined together or separated out into multiple sub-components. For example, in an implementation the AI agents 210, 222, 232 may be implemented in the form of a configuration file that is executed by a centralized execution engine. As another example, the front-end interface 207 could be combined together with the orchestrator AI agent(s) 210. Other examples are possible as well.

As yet another possibility, certain of the components shown and described above may perform additional or different functionality from what is described above.

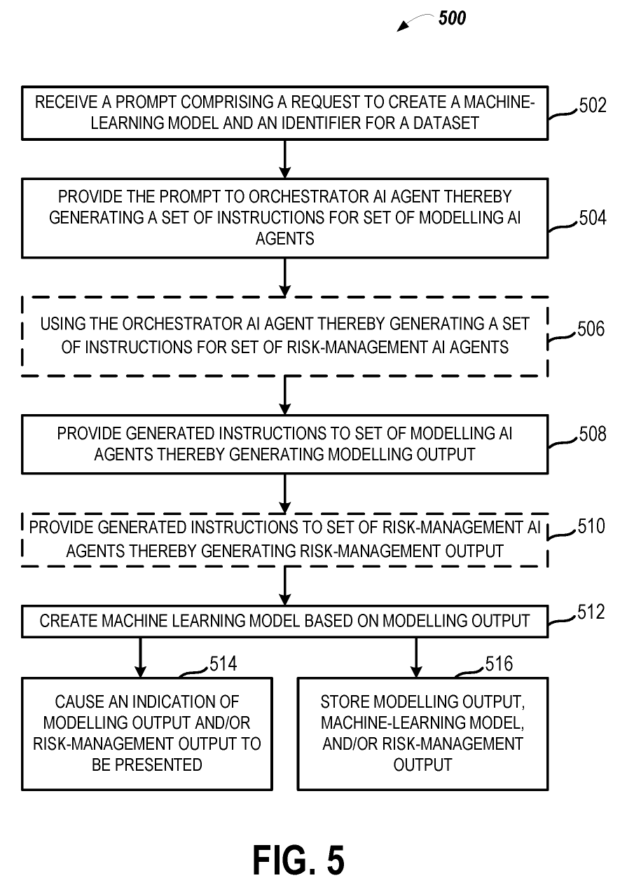

Turning to FIG. 5, example functionality 500 for implementing the disclosed AI-based software technology is illustrated in the form of a flow diagram. For purposes of illustration, the example functionality 500 of FIG. 5 is described as being carried out by the back-end computing platform 102 of FIG. 1, but it should be understood that the example functionality 500 of FIG. 5 may be carried out by any computing platform that is capable of running the software disclosed herein. Further, it should be understood that the example functionality of FIG. 5 is merely described in this manner for the sake of clarity and explanation and that the example functionality may be implemented in various other manners, including the possibility that functions may be added, removed, rearranged into different orders, combined into fewer blocks, and/or separated into additional blocks depending upon the particular example.

As shown in FIG. 5, the example functionality 500 may begin at block 502 with receiving a prompt that comprises (i) a request to create a machine-learning model and (ii) an identifier for a dataset. In some examples, the prompt may, additionally or alternatively, comprise (i) a request to validate a machine-learning model and (ii) an identifier for the machine-learning model. In line with the previous discussion with respect to the example AI-based software architecture 200, the received prompt may take various forms, and the user input may be initiated at any of various times.

At block 504, the disclosed AI-based software technology may involve providing the prompt to an orchestrator artificial intelligence (AI) agent. The orchestrator AI agent(s) may be configured to (i) utilize a generative AI model to decompose the request to generate the machine-learning model into a set of modelling tasks, (ii) generate instructions for a set of modelling AI agents, each modelling AI agent in the set of modelling AI agents configured to carry out a corresponding task of the set of modelling tasks (iii) pass the identifier for the dataset and the instructions for the set of modelling AI agents to the set of modelling AI agents, and (iv) receive modelling output from the set of modelling AI agents.

As an optional step, at block 506, the disclosed AI-based software technology may involve using the orchestrator AI agent(s) to further generate a set of instructions for a set of risk-management AI agents. In such an example, the orchestrator AI agent(s) may be configured to (i) utilize a generative AI model to decompose the request to validate the machine-learning model into a set of risk-management tasks, (ii) generate instructions for a set of risk-management AI agents, each risk-management AI agent in the set of risk-management AI agents configured to carry out a corresponding task of the set of risk-management tasks (iii) pass the identifier for the dataset and the instructions for the set of risk-management AI agents to the set of risk-management AI agents, and (iv) receive risk-management output from the set of risk-management AI agents.

At block 508, the disclosed AI-based software technology may involve providing, via the orchestrator AI agent(s), the instructions for the set of modelling AI agents to the set of modelling AI agents. Each of the set of modelling AI agents are configured to (i) utilize a second generative AI model to, based on respective instructions of the set of instructions, generate input to a respective modelling function of a set of modelling functions for the modelling AI agents, the respective modelling function corresponding to a respective modelling task of the set of modelling tasks, (ii) based on the input for the modeling function, carry out the respective modelling function thereby generate respective modelling output corresponding to the respective modelling task, and (iii) pass the respective modelling output corresponding to the respective modelling task to the orchestrator AI agent(s).

As an optional step, at block 510, the disclosed AI-based software technology may involve providing, using the orchestrator AI agent(s), the set of risk-management tasks to the set of risk-management AI agents. Each of the set of risk-management AI agents is configured to (i) utilize a generative AI model to, based on respective instructions of the set of instructions for the set of risk-management AI agents, generate input to a respective risk-management function of a set of risk-management functions, the respective risk-management function corresponding to a respective risk-management task of the set of risk-management tasks, (ii) based on the input for the risk-management function, carry out the respective risk-management function to thereby generate respective risk-management output corresponding to the respective risk-management task, and (iii) pass the risk-management output corresponding to the respective risk-management task to the orchestrator AI agent(s).

At block 512, the disclosed AI-based software technology may involve creating the machine-learning model based on the modelling output received by the orchestrator AI agent(s).

At block 514, the disclosed AI-based software technology may involve causing an indication of the modelling output and/or the risk-management output to be presented to a user (e.g., via a client device 104). In some additional or alternative examples and illustrated at block 516, the disclosed AI-based software technology may involve storing the modelling output, the machine-learning model, and/or the risk-management output to data storage.

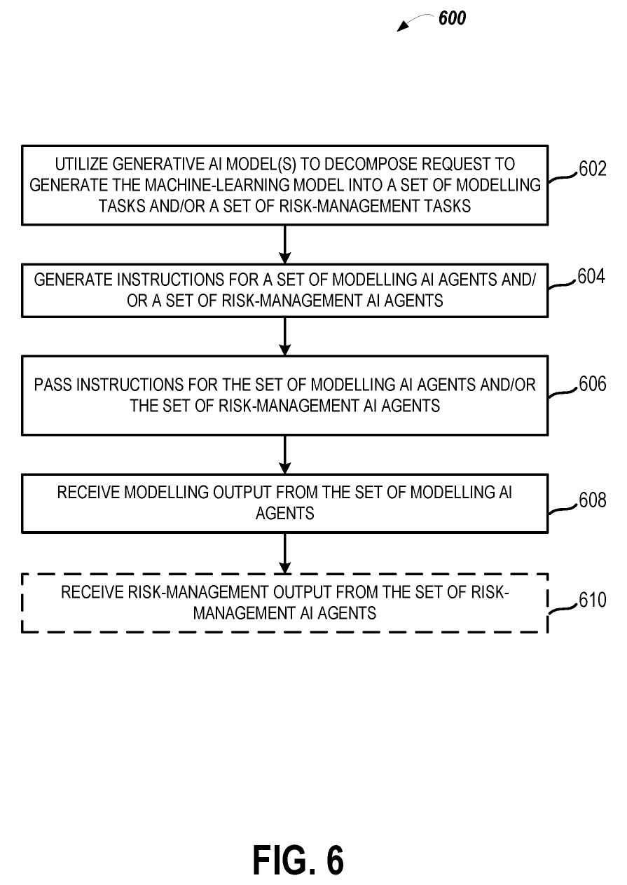

Turning now to FIG. 6, example functionality 600 for implementing the disclosed orchestrator AI agent(s) (e.g., the orchestrator AI agent(s) 210) is illustrated in the form of a flow diagram. For purposes of illustration, the example functionality 600 of FIG. 6 is described as being carried out by the back-end computing platform 102 of FIG. 1, but it should be understood that the example functionality 600 of FIG. 6 may be carried out by any computing platform that is capable of running the software disclosed herein. Further, it should be understood that the example functionality of FIG. 6 is merely described in this manner for the sake of clarity and explanation and that the example functionality may be implemented in various other manners, including the possibility that functions may be added, removed, rearranged into different orders, combined into fewer blocks, and/or separated into additional blocks depending upon the particular example.

As shown in FIG. 6, the example functionality 600 may begin at block 602 with the disclosed orchestrator AI agent(s) utilizing a generative AI model to decompose a request to generate a machine-learning model into a set of modelling tasks. In some examples, this functionality may additionally or alternatively comprise utilizing a generative AI model to decompose a request to validate a machine-learning model into a set of risk-management tasks. In practice, these functions may involve sending a prompt to decompose the request to the generative AI model over an external network-based communication path (e.g., via an API or the like) and then receiving the response from the generative AI model over the external network-based communication path.

At block 604, the disclosed orchestrator AI agent(s) may generate instructions for a set of modelling AI agents and/or for a set of risk-management AI agents, wherein each modelling AI agent in the set of modelling AI agents is configured to carry out a corresponding task of the set of modelling tasks and wherein each risk-management AI agent in the set of risk-management AI agents is configured to carry out a corresponding task of the set of risk-management tasks.

At block 606, the disclosed orchestrator AI agent(s) may (i) pass the identifier for the dataset and the instructions for the set of modelling AI agents to the modelling AI agents and/or may (ii) pass an identifier for a machine-learning model and the instructions for risk-management AI agents to the risk-management AI agents.

At block 608, the disclosed orchestrator AI agent(s) may receive modelling output from the set of modelling AI agents. As an optional step, at block 610, the disclosed orchestrator AI agent(s) may receive risk-management output from the set of risk-management AI agents.

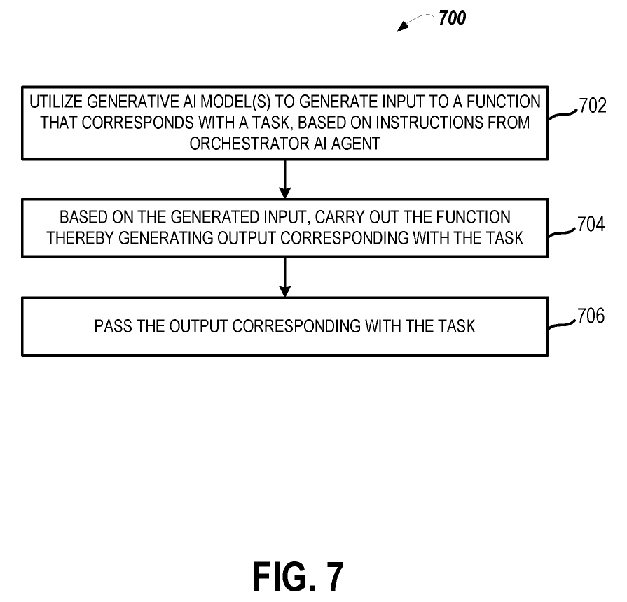

Turning now to FIG. 7, example functionality 700 for implementing the one or more of the AI agents discussed above (e.g., the modelling AI agent(s) 222, 322, the risk-management AI agents 232, 432, etc.) is illustrated in the form of a flow diagram. For purposes of illustration, the example functionality 700 of FIG. 7 is described as being carried out by the back-end computing platform 102 of FIG. 1, but it should be understood that the example functionality 700 of FIG. 7 may be carried out by any computing platform that is capable of running the software disclosed herein. Further, it should be understood that the example functionality of FIG. 7 is merely described in this manner for the sake of clarity and explanation and that the example functionality may be implemented in various other manners, including the possibility that functions may be added, removed, rearranged into different orders, combined into fewer blocks, and/or separated into additional blocks depending upon the particular example.

As shown in FIG. 7, the example functionality 700 may begin at block 702 with the disclosed example AI agent utilizing a generative AI model to, based on instructions of a set of instructions, generate input to a respective function of a set of functions for each of a set of AI agents. The functions each correspond to a respective task of a set of tasks. In practice, the functionality of block 702 may involve sending a prompt to generate input to a function to the generative AI model over an external network-based communication path (e.g., via an API or the like) and then receiving the response from the generative AI model over the external network-based communication path.

At block 704, the example AI agent may, based on the input for the respective function, carry out the respective function thereby generating respective output corresponding to the respective task.

At block 706, the example AI agent may pass the respective output corresponding to the respective task to the orchestrator AI agent(s).

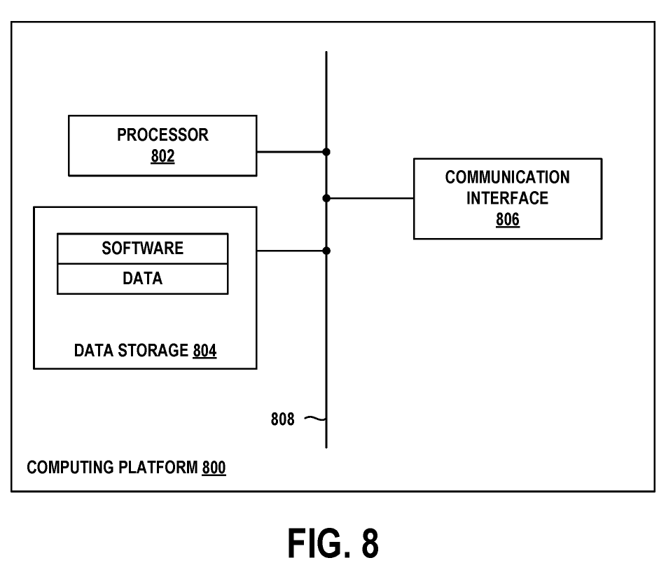

Turning now to FIG. 8, a simplified block diagram is provided to illustrate some structural components that may be included in an example computing platform 800 that may be configured to perform the platform-side functions disclosed herein. At a high level, the example computing platform 800 may generally comprise any one or more computer systems (e.g., one or more servers) that collectively include one or more processors 802, data storage 804, and one or more communication interfaces 806, each of which may be communicatively linked by a communication link 808 that may take the form of a system bus, a communication network such as a public, private, or hybrid cloud, or some other connection mechanism. Each of these components may take various forms.

For instance, the one or more processors 802 may comprise one or more processor components, such as one or more central processing units (CPUs), graphics processing units (GPUs), neural processing units (NPUs), application-specific integrated circuits (ASICs), digital signal processor (DSPs), and/or programmable logic devices such as field programmable gate arrays (FPGAs), among other possible types of processing components. In line with the discussion above, it should also be understood that the one or more processors 802 could comprise processing components that are distributed across a plurality of physical computing devices connected via a network, such as a computing cluster of a public, private, or hybrid cloud.

In turn, the data storage 804 may comprise one or more non-transitory computer-readable storage mediums, examples of which may include volatile storage mediums such as random-access memory, registers, cache, etc. and non-volatile storage mediums such as read-only memory, a hard-disk drive, a solid-state drive, flash memory, an optical-storage device, etc. In line with the discussion above, it should also be understood that the data storage 804 may comprise computer-readable storage mediums that are distributed across a plurality of physical computing devices connected via a network, such as a storage cluster of a public, private, or hybrid cloud that operates according to technologies such as AWS for Elastic Compute Cloud, Simple Storage Service, etc.

As shown in FIG. 8, the data storage 804 may be capable of storing both (i) program instructions that are executable by the one or more processors 802 such that the example computing platform 800 is configured to perform any of the various functions disclosed herein (including but not limited to any of the server-side functions discussed above), and (ii) data that may be received, derived, or otherwise stored by the example computing platform 800.

The one or more communication interfaces 806 may comprise one or more interfaces that facilitate communication between the example computing platform 800 and other systems or devices, where each such interface may be wired and/or wireless and may communicate according to any of various communication protocols. As examples, the one or more communication interfaces 806 may take include an Ethernet interface, a serial bus interface (e.g., Firewire, USB 3.0, etc.), a chipset and antenna adapted to facilitate any of various types of wireless communication (e.g., Wi-Fi communication, cellular communication, Bluetooth® communication, etc.), and/or any other interface that provides for wireless or wired communication. Other configurations are possible as well.

Although not shown, the example computing platform 800 may additionally have an Input/Output (I/O) interface that includes or provides connectivity to I/O components that facilitate user interaction with the example computing platform 800, such as a keyboard, a mouse, a trackpad, a display screen, a touch-sensitive interface, a stylus, a virtual-reality headset, and/or one or more speaker components, among other possibilities.

It should be understood that the example computing platform 800 is one example of a computing platform that may be used with the examples described herein. Numerous other arrangements are possible and contemplated herein. For instance, in other examples, the example computing platform 800 may include additional components not pictured and/or more or less of the pictured components.

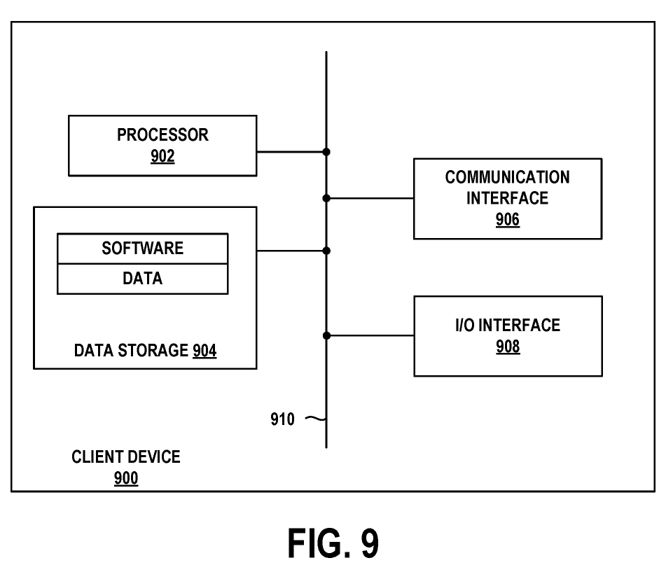

Turning next to FIG. 9, a simplified block diagram is provided to illustrate some structural components that may be included in an example client device 900 that may be configured to perform some the client-side functions disclosed herein. At a high level, the example client device 900 may include one or more processors 902, data storage 904, one or more communication interfaces 906, and an I/O interface 908, each of which may be communicatively linked by a communication link 910 that may take the form a system bus and/or some other connection mechanism. Each of these components may take various forms.

For instance, the one or more processors 902 of the example client device 900 may comprise one or more processor components, such as one or more CPUs, GPUs, NPUs, ASICs, DSPs, and/or programmable logic devices such as FPGAs, among other possible types of processing components.

In turn, the data storage 904 of the example client device 900 may comprise one or more non-transitory computer-readable mediums, examples of which may include volatile storage mediums such as random-access memory, registers, cache, etc. and non-volatile storage mediums such as read-only memory, a hard-disk drive, a solid-state drive, flash memory, an optical-storage device, etc. As shown in FIG. 9, the data storage 904 may be capable of storing both (i) program instructions that are executable by the one or more processors 902 of the example client device 900 such that the example client device 900 is configured to perform any of the various functions disclosed herein (including but not limited to any of the client-side functions discussed above), and (ii) data that may be received, derived, or otherwise stored by the example client device 900.

The one or more communication interfaces 906 may comprise one or more interfaces that facilitate communication between the example client device 900 and other systems or devices, where each such interface may be wired and/or wireless and may communicate according to any of various communication protocols. As examples, the one or more communication interfaces 906 may take include an Ethernet interface, a serial bus interface (e.g., Firewire, USB 3.0, etc.), a chipset and antenna adapted to facilitate any of various types of wireless communication (e.g., Wi-Fi communication, cellular communication, Bluetooth® communication, etc.), and/or any other interface that provides for wireless or wired communication. Other configurations are possible as well.

The I/O interface 908 may generally take the form of (i) one or more input interfaces that are configured to receive and/or capture information at the example client device 900 and (ii) one or more output interfaces that are configured to output information from the example client device 900 (e.g., for presentation to a user). In this respect, the one or more input interfaces of I/O interface may include or provide connectivity to input components such as a microphone, a camera, a keyboard, a mouse, a trackpad, a touchscreen, and/or a stylus, among other possibilities, and the one or more output interfaces of the I/O interface 908 may include or provide connectivity to output components such as a display screen and/or an audio speaker, among other possibilities.

It should be understood that the example client device 900 is one example of a client device that may be used with the examples described herein. Numerous other arrangements are possible and contemplated herein. For instance, in other examples, the example client device 900 may include additional components not pictured and/or more or fewer of the pictured components.

### CONCLUSION

This disclosure makes reference to the accompanying figures and several example embodiments. One of ordinary skill in the art should understand that such references are for the purpose of explanation only and are therefore not meant to be limiting. Part or all of the disclosed systems, devices, and methods may be rearranged, combined, added to, and/or removed in a variety of manners without departing from the true scope and spirit of the present invention, which will be defined by the claims.

Further, to the extent that examples described herein involve operations performed or initiated by actors, such as “humans,” “curators,” “users” or other entities, this is for purposes of example and explanation only. The claims should not be construed as requiring action by such actors unless explicitly recited in the claim language.

We claim:

1. A computing platform comprising:
at least one processor;
at least one non-transitory computer-readable medium; and
program instructions stored on the at least one non-transitory computer-readable medium that, when executed by the at least one processor, cause the computing platform to:
receive a prompt that comprises (i) a request to create a machine-learning model and (ii) an identifier for a dataset;
provide the prompt to an orchestrator artificial intelligence (AI) agent that is configured to (i) utilize a first generative AI model to decompose the request to generate the machine-learning model into a set of modelling tasks, (ii) generate instructions for a set of modelling AI agents, each modelling AI agent in the set of modelling AI agents configured to carry out a corresponding task of the set of modelling tasks (iii) pass the identifier for the dataset and the instructions for the set of modelling AI agents to the set of modelling AI agents, and (iv) receive modelling output from the set of modelling AI agents;
provide, via the orchestrator AI agent, the instructions for the set of modelling AI agents to the set of modelling AI agents that are each configured to (i) utilize a second generative AI model to, based on respective instructions of the set of instructions, generate input to a respective modelling function of a set of modelling functions for the modelling AI agents, the respective modelling function corresponding to a respective modelling task of the set of modelling tasks, (ii) based on the input for the modeling function, carry out the respective modelling function thereby generate respective modelling output corresponding to the respective modelling task, and (iii) pass the respective modelling output corresponding to the respective modelling task to the orchestrator AI agent;
create the machine-learning model based on the modelling output received by the orchestrator AI agent; and
cause an indication of the modelling output to be presented.

2. The computing platform of claim 1, wherein the program instructions stored on the at least one non-transitory computer-readable medium that, when executed by the at least one processor, cause the computing platform to create the machine-learning model based on the modelling output comprises:
using the orchestrator AI agent, creating the machine-learning model based on the modelling output.

3. The computing platform of claim 1, wherein at least one of the set of modelling AI agents generates the input for the respective modelling function of the set of modelling functions based on the dataset.

4. The computing platform of claim 1, wherein passing, by the respective modelling AI agent, the respective modelling output comprises passing the respective modelling output to (i) the orchestrator AI agent, (ii) another modelling agent of the set of modelling AI agents, (iii) another set of AI agents, or (iv) combinations thereof.

5. The computing platform of claim 1, wherein the orchestrator AI agent is further configured to store the modelling output, and
wherein the set of modelling AI agents accesses the modelling output.

6. The computing platform of claim 1, wherein the second generative AI model comprises the first generative AI model.

7. The computing platform of claim 1, wherein the set of modelling AI agents comprises one or more of an exploratory data analysis (EDA) AI agent, a feature-engineering AI agent, a model-selection AI agent, a hyperparameter-tuning AI agent, a model-training AI agent, a model-evaluation AI agent, a documentation agent or combinations thereof.

8. The computing platform of claim 1, wherein each of the set of modelling AI agents comprises a respective role parameter.

9. The computing platform of claim 8, wherein each respective role parameter comprises one of a data scientist role, a machine-learning engineer role, or combinations thereof.

10. A non-transitory computer-readable medium having stored thereon program instructions that, when executed by at least one processor, cause a computing platform to:
receive a prompt that comprises (i) a request to create a machine-learning model and (ii) an identifier for a dataset;
provide the prompt to an orchestrator artificial intelligence (AI) agent that is configured to (i) utilize a first generative AI model to decompose the request to generate the machine-learning model into a set of modelling tasks, (ii) generate instructions for a set of modelling AI agents, each modelling AI agent in the set of modelling AI agents configured to carry out a corresponding task of the set of modelling tasks (iii) pass the identifier for the dataset and the instructions for the set of modelling AI agents to the set of modelling AI agents, and (iv) receive modelling output from the set of modelling AI agents;
provide, via the orchestrator AI agent, the instructions for the set of modelling AI agents to the set of modelling AI agents that are each configured to (i) utilize a second generative AI model to, based on respective instructions of the set of instructions, generate input to a respective modelling function of a set of modelling functions for the modelling AI agents, the respective modelling function corresponding to a respective modelling task of the set of modelling tasks, (ii) based on the input for the modeling function, carry out the respective modelling function thereby generate respective modelling output corresponding to the respective modelling task, and (iii) pass the respective modelling output corresponding to the respective modelling task to the orchestrator AI agent;
create the machine-learning model based on the modelling output received by the orchestrator AI agent; and
cause an indication of the modelling output to be presented.

11. The non-transitory computer-readable medium of claim 10, wherein the program instructions that, when executed by the at least one processor, cause the computing platform to create the machine-learning model based on the modelling output comprises:
using the orchestrator AI agent, creating the machine-learning model based on the modelling output.

12. The non-transitory computer-readable medium of claim 10, wherein passing, by the respective modelling AI agent, the respective modelling output comprises passing the respective modelling output to (i) the orchestrator AI agent, (ii) another modelling agent of the set of modelling AI agents, (iii) another set of AI agents, or (iv) combinations thereof.

13. The non-transitory computer-readable medium of claim 10, wherein the orchestrator AI agent is further configured to store the modelling output, and
wherein the set of modelling AI agents accesses the modelling output.

14. The non-transitory computer-readable medium of claim 10, wherein the set of modelling AI agents comprises one or more of an exploratory data analysis (EDA) AI agent, a feature-engineering AI agent, a model-selection AI agent, a hyperparameter-tuning AI agent, a model-training AI agent, a model-evaluation AI agent, or combinations thereof.

15. The non-transitory computer-readable medium of claim 10, wherein each of the set of modelling AI agents comprises a respective role parameter.

16. The non-transitory computer-readable medium of claim 15, wherein each respective role parameter comprises one of a data scientist role, a machine-learning engineer role, or combinations thereof.

17. A method carried out by a computing platform, the method comprising:
receiving a prompt that comprises (i) a request to create a machine-learning model and (ii) an identifier for a dataset;
providing the prompt to an orchestrator artificial intelligence (AI) agent that is configured to (i) utilize a first generative AI model to decompose the request to generate the machine-learning model into a set of modelling tasks, (ii) generate instructions for a set of modelling AI agents, each modelling AI agent in the set of modelling AI agents configured to carry out a corresponding task of the set of modelling tasks (iii) pass the identifier for the dataset and the instructions for the set of modelling AI agents to the set of modelling AI agents, and (iv) receive modelling output from the set of modelling AI agents;
providing, via the orchestrator AI agent, the instructions for the set of modelling AI agents to the set of modelling AI agents that are each configured to (i) utilize a second generative AI model to, based on respective instructions of the set of instructions, generate input to a respective modelling function of a set of modelling functions for the modelling AI agents, the respective modelling function corresponding to a respective modelling task of the set of modelling tasks, (ii) based on the input for the modeling function, carry out the respective modelling function thereby generate respective modelling output corresponding to the respective modelling task, and (iii) pass the respective modelling output corresponding to the respective modelling task to the orchestrator AI agent;
creating the machine-learning model based on the modelling output received by the orchestrator AI agent; and
causing an indication of the modelling output to be presented.

18. The method of claim 17, wherein each of the set of modelling AI agents comprises a respective role parameter, and
wherein each respective role parameter comprises one of a data scientist role, a machine-learning engineer role, or combinations thereof.

19. The method of claim 17, wherein passing, by the respective modelling AI agent, the respective modelling output comprises passing the respective modelling output to (i) the orchestrator AI agent, (ii) another modelling agent of the set of modelling AI agents, (iii) another set of AI agents, or (iv) combinations thereof.

20. The method of claim 17, wherein the orchestrator AI agent is further configured to store the modelling output, and
wherein the set of modelling AI agents accesses the modelling output.
